(19) United States
(12) Patent Application Publication
(10) Pub. No.: US 2016/0042452 A1
(43) Pub. Date: Feb. 11, 2016

(54) SOFTWARE SYSTEM FOR GRADUALLY PURCHASING A REAL ESTATE PROPERTY

(71) Applicant: Michele GIUDILLI, Mattinata (FG) (IT)

(72) Inventor: Michele GIUDILLI, Mattinata (FG) (IT)

(21) Appl. No.: 14/918,411

(22) Filed: Oct. 20, 2015

Related U.S. Application Data
(63) Continuation-in-part of application No. 13/567,170, filed on Aug. 6, 2012, now abandoned.

(51) Int. Cl. G06Q 40/02; G06Q 50/16; G06Q 40/06

(52) U.S. Cl. CPC G06Q 40/025; G06Q 40/06; G06Q 50/167

(57) ABSTRACT

A software system for gradually purchasing a real estate property, comprising a gradual acquisition plan on the part of a purchaser of an estate which is registered in the name of a legal entity represented by quotas; the quotas are transferred by the bank, owner of the legal entity holder of the estate, to the purchaser, according to a certain gradual reacquisition plan; the method includes reacquisition phases on the part of said purchaser of quota or portions of it through the payment, to the bank, of monthly installments, each including the quota value and relative interest; said quotas can be exchanged by an electronic system in order to exchange the estate with another property by mean their respective legal entity.

### RELATED APPLICATIONS

This non-provisional U.S. patent application is a Continuation-In-Part of U.S. patent application Ser. No. 13/567,170 filed on Aug. 6, 2012.

### BACKGROUND OF THE INVENTION

At present, when a person intends to purchase a property for residential purposes, the buyer has different options if he/she does not have the necessary amount of money for purchasing it, such as opening a mortgage or signing an estate leasing contract. Otherwise, the most economical way of having a house is to rent it, with the disadvantage that the money paid cannot be used to purchase the house.

Social categories consisting of low-income workers, students, temporary workers, immigrants, everybody with a poor credit score, or with a little money available for a down payment, due the hard rules in the light of the consequences of the past subprime crisis, will have difficulty purchasing a house, as it is assumed that in the future there will no longer be subprime loans and consequently they will be forced to pay a rent to house owners, without the possibility of fulfilling their “American dream”. At the same time, homeowners that have a mortgage loan to acquire a property have seen how many problem a debt-based mortgage loan causes. After the crisis many mortgage owners have problems in repaying the loan with the foreclosure as extreme consequence of their inability to meet the repayment. Mortgage loans have little flexibility with the repayments, with the limit with the possibility to skip an installment or to repay the interest only for a limited period of time. Another limitation of the present traditional financing instruments is that, in case of moving or being transferred, either work-related or for personal reasons, to another area of the city or to a city in another state, a house owner who has a mortgage must sell his house, pay the remaining debt and buy another house in the new area, starting a new mortgage. The current financial system for purchasing a house is rigid and makes the property title of the house “immovable”, when the American society has always been characterized by a great mobility of its citizens within the whole national territory. A solution capable of making the ownership of a house more “personal” would be highly appreciated, with a flexible repurchase plan, no longer based on the concept of “debt” but on “equity” where house ownership is represented by a variable number of quotas and with a gradual acquisition system.

The system of the present invention is a computerized system that allows to implement, as an end result, a new method to acquire a property, such a residential home or a commercial property, or a land o any type of expensive assets, not limited to only real estate but also to boats, aircrafts, large ships, industrial plant or any type of infrastructure or projects that require a financing.

### DESCRIPTION OF THE DRAWINGS

The computerized system here presented will be best understood by reference the following drawings and detailed description

FIG. 1 is a diagram of the main application system showing the parties involved in the process, with a generic view of the main software architecture sub-system.

FIG. 1a is the correspondent diagram of FIG. 1 showing the hardware architecture.

FIG. 2 is a diagram of the process to acquire a property depicting all parties involved.

FIG. 3 is the block diagram of the process to establish a new reacquisition plan of a real estate property.

FIG. 4 is a block diagram showing the procedural steps to calculate quota value of the legal entity according to its real estate value.

FIG. 5 is a block diagram that shows the monthly quota allocation by the system based on the successful, or no, of a monthly installment.

FIG. 6 is a computer screen output that shows the main data of a repurchase plan.

FIG. 7 and FIG. 7a are two screenshots of an application software, installed on a smartphone, where the customer, the purchaser of the real estate property, can access information about its plan and quota account, using a text and graphical display.

FIG. 8 is a block diagram showing a further implementation based on the conversion of a traditional, current mortgage loan into a plan using the novel method of the present invention.

FIG. 9 is a computer screen output of a website version of the secondary marketplace, with an example of a listing of a property acquired using the novel system of the present invention.

### SUMMARY OF THE INVENTION

An objective of the present invention is to disclose a new computer-based financing system for purchasing of a real estate property or capital assets, through a system which is accessible in terms of acquisition and does not require a usual evaluation of the credit score, allows the gradual acquisition of the property quotas of the property and, at the same time, allows a strong social mobility, i.e., in the case of relocation of the mortagor from one city to another, it allows the earned quotas of a real estate property to be transferred and used for the purchase of another one. At the same time, the system offers the possibility of utilizing and accumulating property quotas of an estate and consequently to accumulate a capital represented by the real estate property.

In the same way, the same system is used when the property is a capital assets, such as vessels, ships, aircrafts, and other high capital-intensive items, to provide an alternative solution to a long term debt financing.

The system is a computerized software system that is based on the interaction of multiple software sub systems to create a full-automated system that allows to acquire a real estate property transforming this assets into equity securities, in a way that is complete different when compared to a traditional debt based mortgage.

### DESCRIPTION OF THE INVENTION

The system described herein allows special legal entities to be created, through the use of a computerized system, which allows the ownership of an estate to be represented as quotas of this legal entities, through the subdivision of its value into a certain number of ownership quotas, the value of each quota, the cost of each monthly installment; this system allows the gradual reacquisition of the property and favours the exchange of these quotas between the interested players, through an online marketplace system.

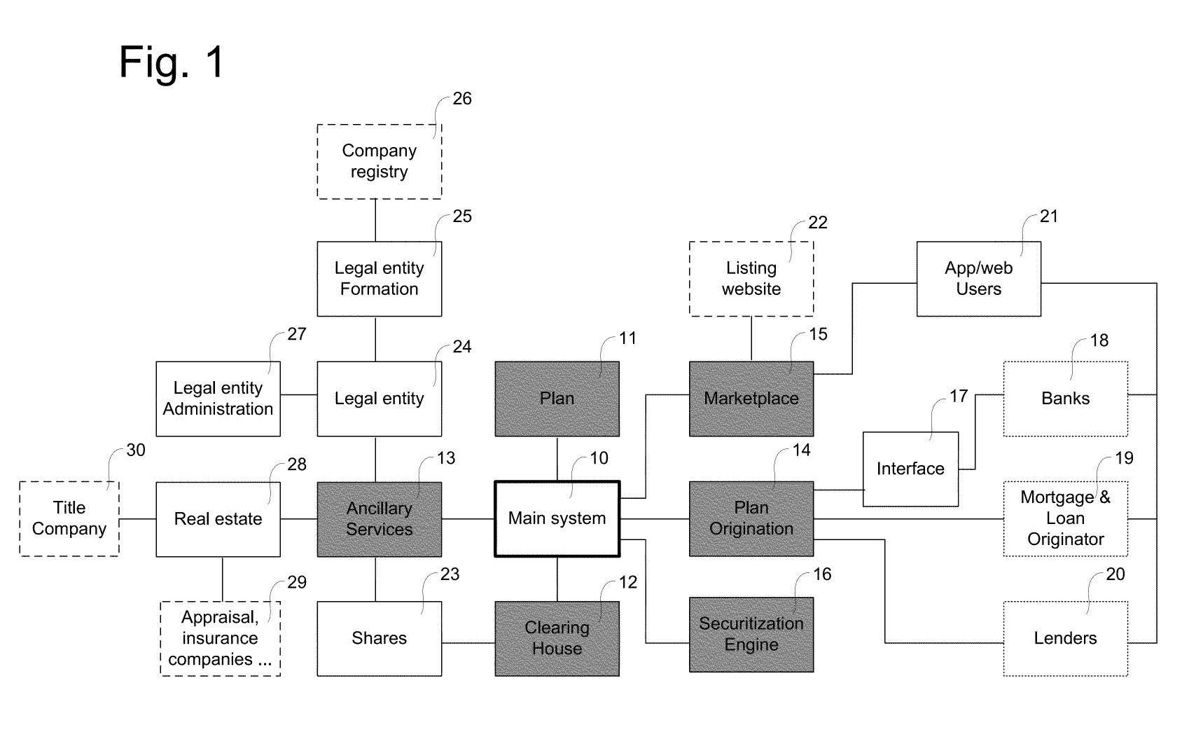

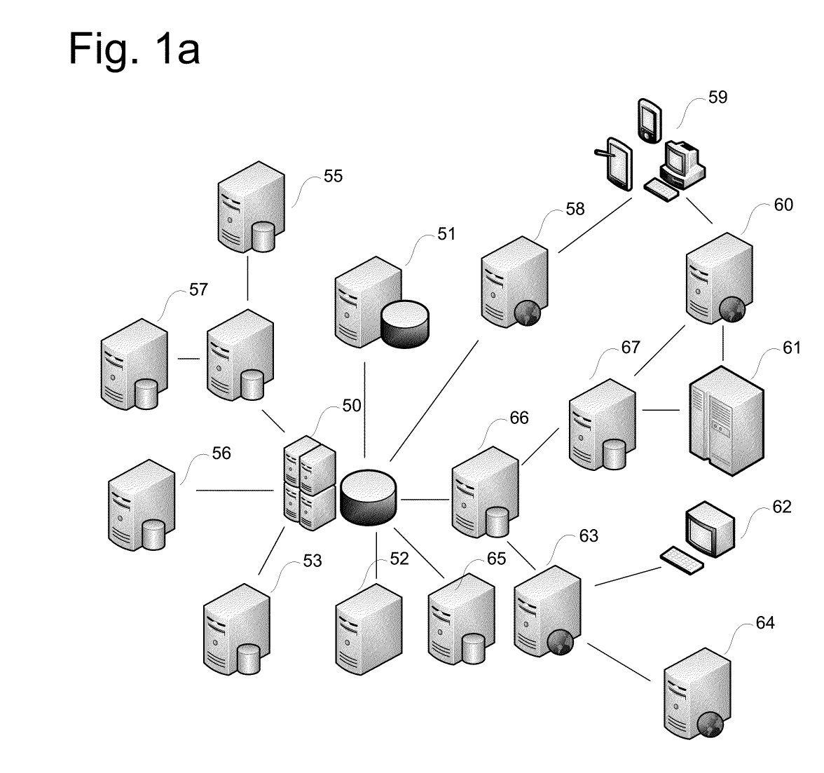

FIG. 1 shows the main diagram of the entire system, the information system and sub-systems involved and the parties involved in the transaction. The diagram must be considered as a high-level architecture of the entire system, as an abstract representation of the main functions of each component. Every component must be intended as a complex software system with their software, data base, queries and applications, and their hardware facilities. The diagram of FIG. 1 represents a preferred embodiment of the present system, while the invention could be carry out in other ways within the same scope of the invention. The computerized system of the present invention is a securities-based repurchase plan of a legal entity that holds a real estate property.

The Main System (10) is the core of the entire system and is a software application running on a server that coordinates the request from each client, and from each subsystem. The main subsystems are those represented in grey, and are:
a) An Ancillary Services subsystem (13), a sub-component that comprises, other subsystems (25, 24, 27, 28, 23) where each one acts on a “database”. Legal Entity (24) is a software application and related database of the legal entities (name of legal entity, address, legal form, quotas numbers, quotas value, etc) and software application capable to create new legal entities via a Legal Entity Formation subsystem (25) by accessing an external computerized system (26) of government. Legal Entity Administration subsystem (27) to provide high-level automated accounting & administration tasks for each legal entity. A further sub-component is the Real Estate subsystem (28) that is a software application and related database that includes all the data for each real estate properties acquired under this system. The data include, address, GPS position, type of property and all the data used to classify a real estate property including cadastral data. The real state database could be accessible to pre-authorized third parties, such a Title Company computer system (30) and other external computer system (29) of appraisal companies, and, as well, the real estate database subsystem could have access to other parties involved in the real estate industry. The third database is the Shares subsystems (23), a software application and related databases, that contain the name, the quota owned for each quota owner of such legal entity, and the transaction history of the quotas and their transferring between parties involved in the repurchase plan execution.
b) Plan subsystem (11) is a sub-component of the main system, that includes servers and software applications and a database that include data for repurchase plans issued, with information storage of value of the plan, number of repayments, information about legal entities, and the customer that has subscribed to the repurchase plan.
c) Clearing House subsystem (12) is including servers running a software application that provides clearing house functionality, where for each instruction coming from other subsystems or from the main system (10), the software application provides the transferring of the quota from an account to another, i.e. from the banks/lenders' account to a customer or vice-versa, depending by the quantity of quotas to be transferred. The Clearing House subsystem (12) can access directly of by mean of the Main System (10) to the Shares (23) database in order to update the quota position after the transaction. The Clearing House subsystem is necessary especially in the case of the computerized software system being operated by an organization that opens the system to external banks or financiers or lenders. In this ways while the parties involved in the transaction are many, the requirement of a clearing house application for the transferring of quotas is necessary, in order to guarantee affordability, fast execution time with a high grade of integrity, while a state-of-the-art software is used for the programming of the clearing house subsystem.
d) Origination and Underwriting subsystem (14) is based on a software application and storage means that may running of a server of the financial institution that operates the system here presented or it can operate directly on the servers of the Securitization Engine subsystem (16), or of the Mortgage & Loan Originator companies subsystem (19) or by Lenders subsystem (20). i.e.: a peer-to-peer lending site or a “crowdfunding” site.
The Origination & Underwriting software application comprises functionalities that permit to simulate a new repurchased plan, create a new one, collect all the documents, and all the functionalities used in this type of application known in the art and used for loans and mortgages. Once a plan is approved and financed, it is sent to the main system (10) and it is stored in the Plan subsystem (11) database.

The Securitization Engine subsystem (16) consists of a software application that can be operated on the server of the financial organization that uses the present system or on the system of the banks or other financial organizations. Its function is to create structured securities, like ABS (Asset Based Securities) that are based on the quotas from the repurchased plan. The main feature of the Securitization Engine subsystem is that is a visual tool that reads data from the Plan subsystem (11) and selects all quotas included in the entire set of a repurchase plan considering these main criteria: 1) location, where a set of quotas are from plans related to properties based in a given geographic input as city, county or state or geographical area. 2) type of properties, considering quotas as part of a repurchase plan depending by the properties of the plan: i.e. commercial instead of residential, or, in this case, condo instead of single unit house, etc. 3) credit score of the subscriber of the repurchase plan, that can be selected as a range in order to have quotas owned by subscribers that have a certain credit score values. 4) the fourth criteria specifies the preferred duration of the quotas to be considered. While repurchased plan can have a duration of several years (up to 30 or 40 years), it can be possible to choose the duration of the securities that will have, in this way, all the quotas that must be repurchased within a given time (i.e. within 5 years) will be included in the set of quotas considered for the securitization.

The result of this main four criteria (others can be added but are secondary as relevance) will be a numbers of quotas that satisfy all or part of given criteria that will be included in the securities, with an average interest rate calculated by the system considering the interest applied for each plan, and the total value of the quotas. This set of quotas is extracted after a database query is run with the preferred above criteria, and will be used as the underlying assets to create the structured securities, similar to the ABS or MBS used in the financial system, only that, in our case, they consist of other securities represented by the quotas or the repurchased plan. The yield of these structured securities will depend by the average interest rate of the considered quotas. In the block (31) is indicated a app/web subscriber client that is a website application (in the sense that can be accessible via a computer accessing a private area) or an software application (“app”) running on a smartphone or a tablet that allow access to the marketplace subsystem (15) and to check the account directly from the Banks subsystem (18) or other party (either 19 or 20) online servers (i.e.: the same used for the banking operation provided by every bank in the USA today) in order to see textual and graphic representation of the current plan status. The app/web subscriber client is accessible also via the Marketplace subsystem (15) or directly by the online internet servers eventually provided by the financial organization that operates the system of the present invention. Every person skilled in the art, could implement this system in a way that may be largely different from the above architecture, but with the same scope and effect of the present invention.

Furthermore, the system includes .an Interface (17) application capable to connect banks, mortgage and loan originator company and lenders to the Main System (10) in the ways they can have access to this new system and offer to their customers the advantages of this invention. This interface could be a secure communication link over the Internet to access to an online application where an external party (18, 19,20) can communicate and exchange data with the main system. Alternatively, the interface could be a “middleware software” that allows to the Main System (10) to be accessible from legacy software used by a financial system, or for least, or it could be a software installed on the system of the external parties (18, 19, 20) that provide software applications, including origination & underwriting functions and then can communicate via a secure way with the Main System. So the use of the Interface subsystem (17) application could vary a lot, because while the financial world has many computerized systems with different operating systems, programming languages, and applications, is impossible to provide a detailed list of situations and architectures. For the sake of simplicity refer to an “ideal” interface capable to connect and interoperate the main system (10) with an external system of a third party organization that can be a member of this system.

The Marketplace subsystem (15) will be presented and described in a more detailed way on this document.

FIG. 1a is the correspondence hardware architecture of the Main system logical architecture illustrated in FIG. 1. FIG. 1a and its following description give details of the function of each computerized station. All the physical stations are linked with TCP/IP protocol and are using secure communications and all the state-of-the-art server technology, as well may it maybe implemented as a single server or in a cluster or in more complex cloud-based architecture. Item 50 points to the main system, that is a high performance computer system, made by servers with an high performance relational database storage, in terms of Terabytes scale. Item 51 is the server with a database, running the Plan subsystem (11) software application. The server with database capabilities indicated with 54, 55 e 57, are respectively, the machines which the legal entity subsystem (24), the Legal Entity Formation subsystem (25) and Legal Entity Administration subsystem (27). The server with database capabilities 56 is the Real estate subsystem (28). The server with database 53 is the Shares subsystem (23), while the server indicated with 52 is a high performance server that will perform financial transactions by running the Clearing House software application (12), with few database capabilities, while the output data are stored in Shares databases (23) and in the Plan subsystem (11). On the other side, the item 66 is a server with database .that has the application to permits to create, edit and delete repurchase plans, plus other function accessible to the external parties such as a bank, where other external servers (67, 63) have access. The item 67 is the Interface subsystem (17), as indicated on FIG. 1, that is a middleware software service or software application that allows to interface the information system of the bank, depicted as a mainframe (61) while most banks are old legacy base systems, based on old hardware & programming languages. Naturally, item 67 may not be necessary, and could be optional depending on the system configuration for each bank or financial institution. In fact, the Loan & Mortgage Originator company installation (19) could access the server 66 via a web server (63) using a web based software application using a browser function of the desktop computer (62). Other Lenders subsystem (20) could access the system using another internet server (64) that exchanges data via API, i.e. a social lending online platform that finance the repurchase plans of this system. The internet server 60 is connected to the bank information system (61) or to the computer (67) and provide via internet information to the client indicated with item 59, that are smartphones, tablet, laptop and desktop computers, used by a customer, to access his/her own account to obtain information about hi/her plan status.

The internet server 58 is the machine that provides the services of online marketplace where a customer and prospective customers could access to sell and acquire a repurchase plan or quotas of a plan. The server and database capacity 65 is the Securitization Engine (16) that reads data from the Plan subsystem (51) and allows via an interface to select plans and quotas to be included in the securitized securities. The server 55 has access to a server of the government (not depicted) in order to create/edit/delete/update legal entities electronically based on request from the server 55. The station 56 could access the external computer system (not depicted) of a title company, in order to communicate title status on each property, as well to access the computer system (not depicted) of insurance companies and appraisal companies.

The above hardware architecture, based on the functions that each machine can perform, may be evident to a person skilled in the art that is possible to achieve the same functionality with different architectures and hardware/software implementations, with the same effect of the present invention.

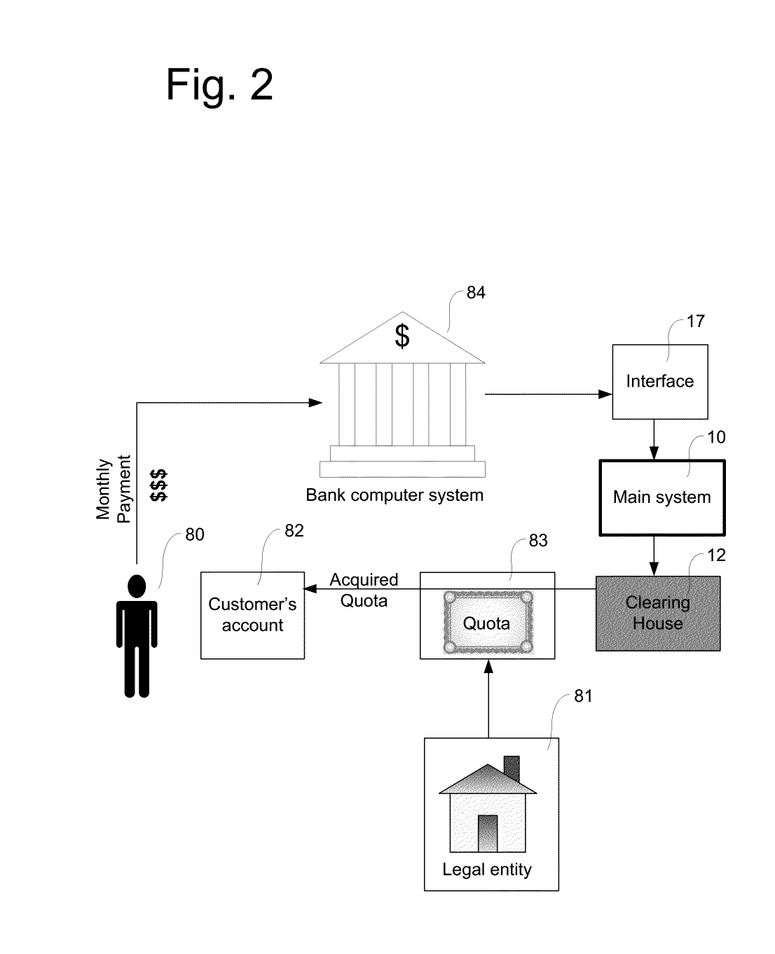

FIG. 2 shows a diagram of parties involved in the system of the present invention and the process itself. In order to implement this gradual reacquisition system and achieve the objectives of the invention, it is necessary that the ownership quotas do not directly refer to a certain property, but the ownership of the latter must be a legal entity (81), (such as a LLC (Limited Liability Company) in whose name the ownership of the estate is registered. A customer (80) who wishes to use this system to acquire a property turns to a bank (84) or a financial company, and the bank which uses the present invention information system. The real estate property is registered in the name of a legal entity (81) and, by signing an agreement, a commitment is established between the future house owner and the bank to implement the repurchase plan system of the property described herein, i.e. the house owner accepts to purchase each month from the bank, a fraction or quota of the legal entity, that is the owner of the property. It is therefore the same as purchasing a quota of the house. This quota is equal to, or mainly equivalent to, the principal portion of a long-term mortgage (from 10-15 to 30-40 years) amortized according to the French method. The payment of an installment grants the right to use the property (as if it was rented) and also allows the entire value of the principal part of the installment to be accumulated into quotas or fractions of the legal entity. The bank undertakes, in exchange of monthly payments, to transfer said quota or fraction of the HPV to the owner according to the present system, by means of a computerized accounting system, here presented. In FIG. 2, showing the monthly routine of transferring quota, where the customer (80) after paying the monthly installment to the bank (84), by accessing via interface (17) the main system (10) asking via an electronic message to the clearing house (12) to transfer the quota (83) to the customer's account (82). The number of quotas of the legal entity depends on how the value of the property is divided up and, even if it can be arbitrary, is preferably defined on the basis of the number of years of duration of the reacquisition plan of the legal entity's quotas according to the present invention. If we consider that an owner wishes to purchase the house in 30 years, then the legal entity will have 360 quotas (or shares or units, each corresponding to a payment month. Therefore, for a house having an acquisition value of $360,000 each quota will have the starting value of $1,000. The customer, future owner, can establish whether he/she intends to immediately purchase a certain number of quotas of the legal entity. This corresponds to a traditional “down payment” which is used in a traditional mortgage contract, in order to reduce the amount financed. If the client decides, for example, to buy 60 quotas related to a down-payment of $60,000, the remaining portion to complete the acquisition of the property will be disbursed by the bank which will acquire 300 quotas of the legal entity of the estate, for an amount of $300,000. It is as if the owner were receiving a loan from the bank of $300,000 he/she does not possess, to allow the purchase of the quotas. The bank, in fact, is not granting a loan to the client/owner, as it has already acquired the quotas (300 for $300,000) but it is a simply financing of the acquisition of a legal entity for which the bank apply a return plan as if it were a loan, using the same calculation parameters applying a French amortization, using a software. The resulting repayment plan comprising the monthly installment to be paid by the customer to the bank, the principal part of said installment corresponds to the quota or fraction of the legal entity, whereas the interest is the remuneration of the capital required by the bank as it has financed the purchase of the house using the system of legal entity's quotas.

Table 1 represents a synthesis of the main data of a plan referring to an estate having a value of 360,000$ with a down-payment of 60,000$, an interest rate of 6% and 360 quotas having a unitary value of 1,000$, of which 60 are initially acquired by down-payment and the remaining 300 must be financed. This plan envisages a monthly installment of 1,798$ calculated with a financial amortization table.

TABLE 1

| | |
|---|---|
| Interest Rate | 6% |
| Property value | $360,000 |
| Year/months repayment | 30/360 |
| Quota Issued Number | 360 |
| Quota Value | $1,000 |
| Down Payment | $60,000 |
| Financing Quota Number | 300 |
| Financing Amount | $300,000 |
| Initial Quota Value | $1,000 |
| Quota Number acquired w/down | 60 |
| payment | |
| Monthly payment | $1,798 |

It is also possible to acquire the property, according to the present system, with no down payment, so that the bank finances 100% of the quotas.

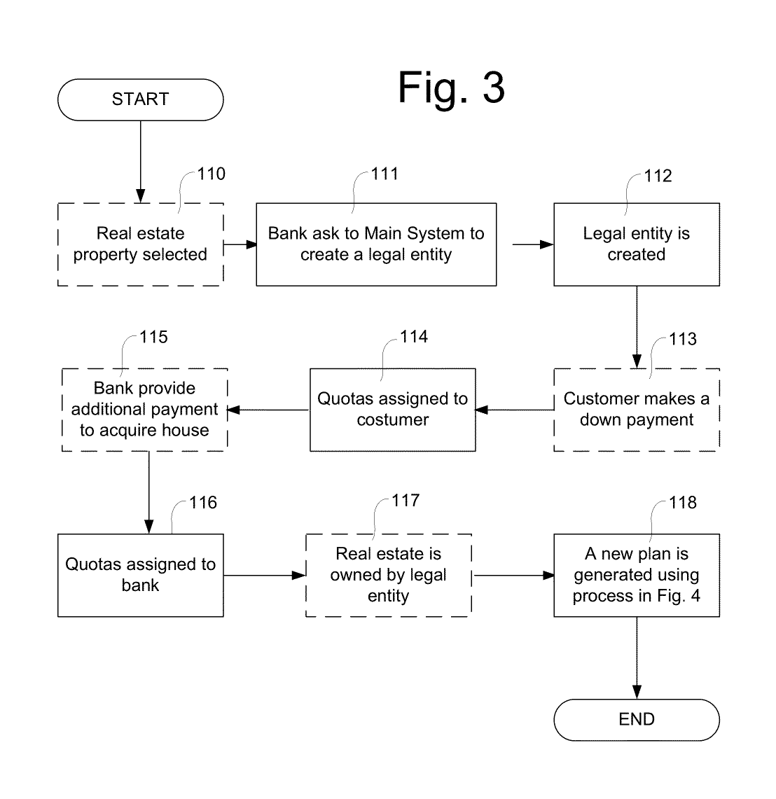

FIG. 3 shows the process at the basis of the present computerized software system, as a block diagram illustrating a preferred embodiment procedure of the process. It will be evident to an expert in the field how to vary this procedure, also by changing the order, without losing the objective and scope of the present invention. The dashed line means a human action, while full lines represent computer-performed actions. At block 110, the client decides to purchase a new property. In case the bank will be available to finance the acquisition of the property using the present system, the bank computerized system will ask to the Main System (10) to create a legal entity. In block 112 the legal entity is created by mean of software subsystem Legal Entity Formation (25).

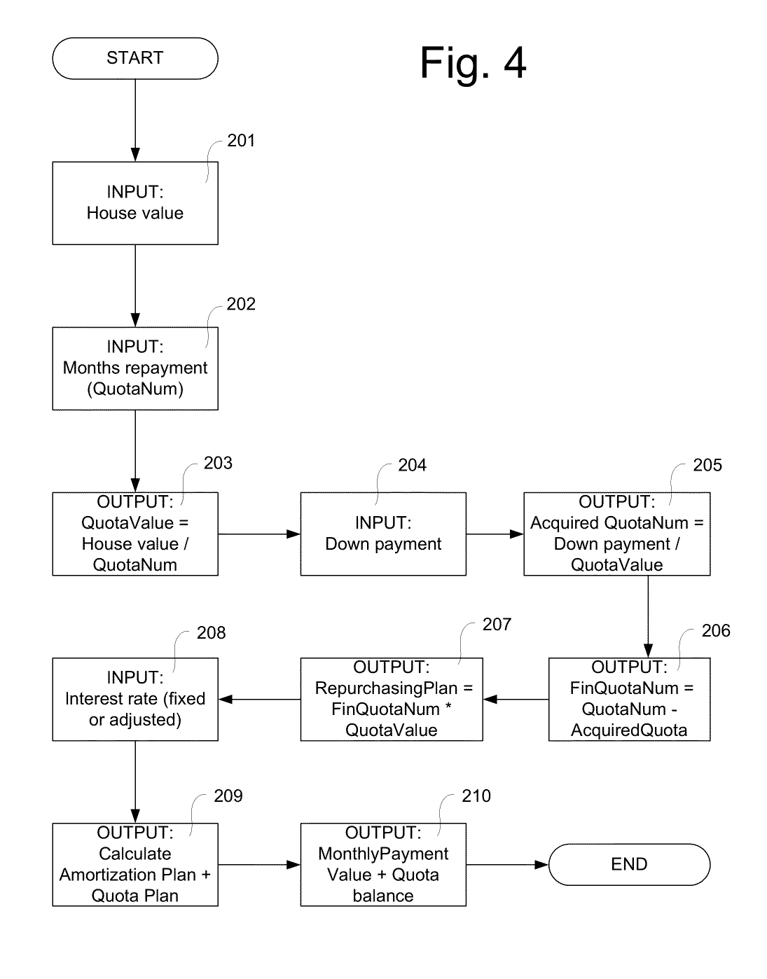

In 113 the customer makes a down payment or guarantee, and in 114 some quotas are transferred on the customer's account, based on the down payment value, by mean of a Clearing House subsystem (12) that will credit the customer's account with a number of quotas. In block 115 the bank provides additional payment to complete the payment for the property value, and in block 116 quotas for the financed value is credited on the bank account by the Clearing House (116). In block 117 the real estate property is now owned by the legal entity, and in block 118 is performed the routine illustrated in FIG. 4 and the new plan is then stored via the Plan subsystem (11) and is effective according to its juridical effect.

In addition to facilitating the acquisition of a house, the system of the present invention does not create any risks for the bank and offers advantages with respect to the bank's balance sheet.

In traditional loans, the bank lends money to a customer so that he/she can purchase a house, and receiving, as guarantee, a mortgage/lien on the estate.

Table 2 shows a brief accounting entry of a traditional loan with the assets and liabilities part of the balance.

TABLE 2
Mortgage value $200,000
Bank balance sheet (value
in $)

| | |
|---|---|
| Assets | Liabilities |

| | | | |
|---|---|---|---|
| Loans | 200,000 | Deposits, other | 200,000 |
| | | liabilities | |

The loan is registered in the “loans” in the part relating to assets, and are covered by deposits of the clients.

In the case of insolvency of the customer, various accounting measures are adopted, with a partial devaluation of the credit in relation to various parameters, such as the value of the estate and sales price. The mortgage does not appear directly on the accounts as it is an off-balance guarantee and consequently it does not appear in the book-keeping accounts.

Table 3 shows the same accounting profile using the system described herein. As the legal entity quotas owned by the bank are financial instruments, they can be accounted under the item “Investments” of the Assets, whereas in the Liabilities, they can have a coverage analogous to that of mortgages or be covered by long-term debt instruments and deposits.

TABLE 3
Quota based plan value $200,000
Bank balance sheet (value in
$)

| | |
|---|---|
| Assets | Liabilities |

| | | | |
|---|---|---|---|
| Investments | 200,000 | Long-term debt, | 200,000 |
| | | deposits | |

In the system of the present invention, the bank is the owner of the quotas, having the legal entity quotas in its possession as financial assets or investment securities. Therefore these quotas are financial activities, in which the guarantee is no longer the mortgage but the same legal entity quotas possessed by the bank and not yet repurchased by the customer. It is therefore an actual guarantee, directly written in the financial statements, with no risk of insolvency of the client, as, in the case of non-payment on the part of the latter, there is no need to devaluate the credit but simply evict the subject in arrears and find a new buyer of the estate, in addition to the recovery of the non-paid installments from the quotas already possessed by the owner according to the present system.

With this system, in fact, what was originally a credit (with mortgages) and therefore a debt, with this novel system it becomes a “security”.

The system described above produces a repurchase plan, based on the following data to be input in the computerized software system, in particular in the Origination & Underwriting (14) subsystem of the Main System (10):
data of the buyer
identification data of the estate
data of the legal entity in whose name the estate is registered
value of the estate
duration of the buying plan
number of quotas
number of quotas acquired by the buyer in the initial phase
insertion of additional costs such as the annual taxes on the estate (property tax), which, in this way, are transferred from the bank to the client, various insurances
administration running costs and annual taxations for maintaining the legal entity.

Using the above data, opportunely formalized in a database format and by software application, the system will generate a repurchase plan of the quotas according to a French amortization plan based on (table 4). The plan will have this data, properly structured:
amount to be financed by the bank
rate of interest to be applied
duration of time within which the quotas are repurchased
annual property taxations, divided into the number of monthly quotas for the reference year
running costs and maintenance taxations of the legal entity, divided into the number of monthly installments for the reference year, including the insurance costs of the property against a series of risks as well as property taxes on the estate. For the sake of simplicity, Table 4 does not show these additional costs.

The repurchase plan with the input data ad the output data are stored in the database of Plan subsystem (11). FIG. 4 shows a block diagram with the method which allows the calculation of the monthly payment and the value of the monthly installments with the relative balance of the same.

The value of the house (201) is inserted, together with the number of months (202) which indicates the duration of the reacquisition plan, obtaining the QuotaNum For the sake of convenience, this number can correspond to the number of quotas, which can be arbitrary, into which the legal entity is divided. In block 203, the computer calculates the value of a single quota (QuotaValue), dividing the value of the house (House Value) by the number of quotas (QuotaNum) to be purchased. The next step comprises the insertion of the value of the possible down-payment (204), whereas step 205 processes the value of the quotas acquired (Acquired QuotaNum) with the down-payment, dividing the down-payment by the unitary value of each quota (QuotaValue). In 206 the number of quotas to be financed (FinQuotaNum) is calculated, i.e. the number of quotas which are allowed to be gradually acquired according to the present invention, by subtracting the number of quotas acquired from the total number of quotas. In 207 the amount of the plan (PurchasePlan) of the financing, is calculated by multiplying the unitary value of the quotas (QuotaValue) by the number of quotas which will be financed (FinQuotaNum). Subsequently, in 208 the interest rate is provided, which can be fixed or is variable and in 209 the repayment plan is calculated, like that shown in table 4, which generates the amount of the monthly installment (210) and the value and balance of the quotas after the payment of each installment.

Table 4 represents the schedule of the French amortization plan indicated in table 3, the last three columns determine, for each month, the amount of the quota acquired, the total of the quotas owned by the bank and the number of quotas accumulated by the customer.

TABLE 4
Financing: $ 300,000 30 year fixed 6% interest rate
Quota value $ 1000

| | | | | | | | Bank | Customer |
|---|---|---|---|---|---|---|---|---|
| Pay- | Principal | Monthly | Principal | Interest | Residual | Quota | owned | owned |
| ment # | Balance | Payment | Amount | Amount | Balance | acquired | quota | quota |
| | | | | | | | | 60 |
| 1 | 300,000.00 | 1,798.65 | 298.65 | 1,500.00 | 299,701.35 | 0.30 | 300.00 | 60.30 |
| 2 | 299,701.35 | 1,798.65 | 300.14 | 1,498.51 | 299,401.20 | 0.30 | 299.70 | 60.60 |
| 3 | 299,401.20 | 1,798.65 | 301.65 | 1,497.01 | 299,099.56 | 0.30 | 299.40 | 60.90 |
| 4 | 299,099.56 | 1,798.65 | 303.15 | 1,495.50 | 298,796.40 | 0.30 | 299.10 | 61.20 |
| 5 | 298,796.40 | 1,798.65 | 304.67 | 1,493.98 | 298,491.73 | 0.30 | 298.80 | 61.51 |
| 6 | 298,491.73 | 1,798.65 | 306.19 | 1,492.46 | 298,185.54 | 0.31 | 298.49 | 61.81 |
| 7 | 298,185.54 | 1,798.65 | 307.72 | 1,490.93 | 297,877.82 | 0.31 | 298.19 | 62.12 |
| 8 | 297,877.82 | 1,798.65 | 309.26 | 1,489.39 | 297,568.56 | 0.31 | 297.88 | 62.43 |
| 9 | 297,568.56 | 1,798.65 | 310.81 | 1,487.84 | 297,257.75 | 0.31 | 297.57 | 62.74 |
| 10 | 297,257.75 | 1,798.65 | 312.36 | 1,486.29 | 296,945.38 | 0.31 | 297.26 | 63.05 |
| 11 | 296,945.38 | 1,798.65 | 313.92 | 1,484.73 | 296,631.46 | 0.31 | 296.95 | 63.37 |
| 12 | 296,631.46 | 1,798.65 | 315.49 | 1,483.16 | 296,315.96 | 0.32 | 296.63 | 63.68 |
| 13 | 296,315.96 | 1,798.65 | 317.07 | 1,481.58 | 295,998.89 | 0.32 | 296.32 | 64.00 |
| 14 | 295,998.89 | 1,798.65 | 318.66 | 1,479.99 | 295,680.24 | 0.32 | 296.00 | 64.32 |
| 15 | 295,680.24 | 1,798.65 | 320.25 | 1,478.40 | 295,359.99 | 0.32 | 295.68 | 64.64 |
| 16 | 295,359.99 | 1,798.65 | 321.85 | 1,476.80 | 295,038.13 | 0.32 | 295.36 | 64.96 |
| 17 | 295,038.13 | 1,798.65 | 323.46 | 1,475.19 | 294,714.67 | 0.32 | 295.04 | 65.29 |
| 18 | 294,714.67 | 1,798.65 | 325.08 | 1,473.57 | 294,389.59 | 0.33 | 294.71 | 65.61 |
| 19 | 294,389.59 | 1,798.65 | 326.70 | 1,471.95 | 294,062.89 | 0.33 | 294.39 | 65.94 |
| 20 | 294,062.89 | 1,798.65 | 328.34 | 1,470.31 | 293,734.55 | 0.33 | 294.06 | 66.27 |
| 21 | 293,734.55 | 1,798.65 | 329.98 | 1,468.67 | 293,404.58 | 0.33 | 293.73 | 66.60 |
| 22 | 293,404.58 | 1,798.65 | 331.63 | 1,467.02 | 293,072.95 | 0.33 | 293.40 | 66.93 |
| 23 | 293,072.95 | 1,798.65 | 333.29 | 1,465.36 | 292,739.66 | 0.33 | 293.07 | 67.26 |
| 24 | 292,739.66 | 1,798.65 | 334.95 | 1,463.70 | 292,404.71 | 0.33 | 292.74 | 67.60 |
| 25 | 292,404.71 | 1,798.65 | 336.63 | 1,462.02 | 292,068.08 | 0.34 | 292.40 | 67.93 |
| 26 | 292,068.08 | 1,798.65 | 338.31 | 1,460.34 | 291,729.77 | 0.34 | 292.07 | 68.27 |
| 27 | 291,729.77 | 1,798.65 | 340.00 | 1,458.65 | 291,389.76 | 0.34 | 291.73 | 68.61 |
| 28 | 291,389.76 | 1,798.65 | 341.70 | 1,456.95 | 291,048.06 | 0.34 | 291.39 | 68.95 |
| 29 | 291,048.06 | 1,798.65 | 343.41 | 1,455.24 | 290,704.65 | 0.34 | 291.05 | 69.30 |
| 30 | 290,704.65 | 1,798.65 | 345.13 | 1,453.52 | 290,359.52 | 0.35 | 290.70 | 69.64 |
| 31 | 290,359.52 | 1,798.65 | 346.85 | 1,451.80 | 290,012.67 | 0.35 | 290.36 | 69.99 |
| 32 | 290,012.67 | 1,798.65 | 348.59 | 1,450.06 | 289,664.08 | 0.35 | 290.01 | 70.34 |
| 33 | 289,664.08 | 1,798.65 | 350.33 | 1,448.32 | 289,313.75 | 0.35 | 289.66 | 70.69 |
| 34 | 289,313.75 | 1,798.65 | 352.08 | 1,446.57 | 288,961.67 | 0.35 | 289.31 | 71.04 |
| 35 | 288,961.67 | 1,798.65 | 353.84 | 1,444.81 | 288,607.82 | 0.35 | 288.96 | 71.39 |
| 36 | 288,607.82 | 1,798.65 | 355.61 | 1,443.04 | 288,252.21 | 0.36 | 288.61 | 71.75 |
| 37 | 288,252.21 | 1,798.65 | 357.39 | 1,441.26 | 287,894.82 | 0.36 | 288.25 | 72.11 |
| 38 | 287,894.82 | 1,798.65 | 359.18 | 1,439.47 | 287,535.64 | 0.36 | 287.89 | 72.46 |
| 39 | 287,535.64 | 1,798.65 | 360.97 | 1,437.68 | 287,174.67 | 0.36 | 287.54 | 72.83 |
| 40 | 287,174.67 | 1,798.65 | 362.78 | 1,435.87 | 286,811.89 | 0.36 | 287.17 | 73.19 |
| 41 | 286,811.89 | 1,798.65 | 364.59 | 1,434.06 | 286,447.30 | 0.36 | 286.81 | 73.55 |
| 42 | 286,447.30 | 1,798.65 | 366.42 | 1,432.24 | 286,080.88 | 0.37 | 286.45 | 73.92 |
| 43 | 286,080.88 | 1,798.65 | 368.25 | 1,430.40 | 285,712.64 | 0.37 | 286.08 | 74.29 |
| 44 | 285,712.64 | 1,798.65 | 370.09 | 1,428.56 | 285,342.55 | 0.37 | 285.71 | 74.66 |
| 45 | 285,342.55 | 1,798.65 | 371.94 | 1,426.71 | 284,970.61 | 0.37 | 285.34 | 75.03 |
| 46 | 284,970.61 | 1,798.65 | 373.80 | 1,424.85 | 284,596.81 | 0.37 | 284.97 | 75.40 |
| 47 | 284,596.81 | 1,798.65 | 375.67 | 1,422.98 | 284,221.14 | 0.38 | 284.60 | 75.78 |
| 48 | 284,221.14 | 1,798.65 | 377.55 | 1,421.11 | 283,843.60 | 0.38 | 284.22 | 76.16 |
| 49 | 283,843.60 | 1,798.65 | 379.43 | 1,419.22 | 283,464.16 | 0.38 | 283.84 | 76.54 |
| 50 | 283,464.16 | 1,798.65 | 381.33 | 1,417.32 | 283,082.83 | 0.38 | 283.46 | 76.92 |
| 51 | 283,082.83 | 1,798.65 | 383.24 | 1,415.41 | 282,699.60 | 0.38 | 283.08 | 77.30 |
| 52 | 282,699.60 | 1,798.65 | 385.15 | 1,413.50 | 282,314.44 | 0.39 | 282.70 | 77.69 |
| 53 | 282,314.44 | 1,798.65 | 387.08 | 1,411.57 | 281,927.36 | 0.39 | 282.31 | 78.07 |
| 54 | 281,927.36 | 1,798.65 | 389.01 | 1,409.64 | 281,538.35 | 0.39 | 281.93 | 78.46 |
| 55 | 281,538.35 | 1,798.65 | 390.96 | 1,407.69 | 281,147.39 | 0.39 | 281.54 | 78.85 |
| 56 | 281,147.39 | 1,798.65 | 392.91 | 1,405.74 | 280,754.47 | 0.39 | 281.15 | 79.25 |
| 57 | 280,754.47 | 1,798.65 | 394.88 | 1,403.77 | 280,359.59 | 0.39 | 280.75 | 79.64 |
| 58 | 280,359.59 | 1,798.65 | 396.85 | 1,401.80 | 279,962.74 | 0.40 | 280.36 | 80.04 |
| 59 | 279,962.74 | 1,798.65 | 398.84 | 1,399.81 | 279,563.90 | 0.40 | 279.96 | 80.44 |
| 60 | 279,563.90 | 1,798.65 | 400.83 | 1,397.82 | 279,163.07 | 0.40 | 279.56 | 80.84 |
| 61 | 279,163.07 | 1,798.65 | 402.84 | 1,395.82 | 278,760.23 | 0.40 | 279.16 | 81.24 |
| 62 | 278,760.23 | 1,798.65 | 404.85 | 1,393.80 | 278,355.38 | 0.40 | 278.76 | 81.64 |
| 63 | 278,355.38 | 1,798.65 | 406.87 | 1,391.78 | 277,948.51 | 0.41 | 278.36 | 82.05 |
| 64 | 277,948.51 | 1,798.65 | 408.91 | 1,389.74 | 277,539.60 | 0.41 | 277.95 | 82.46 |
| 65 | 277,539.60 | 1,798.65 | 410.95 | 1,387.70 | 277,128.65 | 0.41 | 277.54 | 82.87 |
| 66 | 277,128.65 | 1,798.65 | 413.01 | 1,385.64 | 276,715.64 | 0.41 | 277.13 | 83.28 |
| 67 | 276,715.64 | 1,798.65 | 415.07 | 1,383.58 | 276,300.56 | 0.42 | 276.72 | 83.70 |
| 68 | 276,300.56 | 1,798.65 | 417.15 | 1,381.50 | 275,883.42 | 0.42 | 276.30 | 84.12 |
| 69 | 275,883.42 | 1,798.65 | 419.23 | 1,379.42 | 275,464.18 | 0.42 | 275.88 | 84.54 |
| 70 | 275,464.18 | 1,798.65 | 421.33 | 1,377.32 | 275,042.85 | 0.42 | 275.46 | 84.96 |
| 71 | 275,042.85 | 1,798.65 | 423.44 | 1,375.21 | 274,619.41 | 0.42 | 275.04 | 85.38 |
| 72 | 274,619.41 | 1,798.65 | 425.55 | 1,373.10 | 274,193.86 | 0.43 | 274.62 | 85.81 |
| 73 | 274,193.86 | 1,798.65 | 427.68 | 1,370.97 | 273,766.18 | 0.43 | 274.19 | 86.23 |
| 74 | 273,766.18 | 1,798.65 | 429.82 | 1,368.83 | 273,336.36 | 0.43 | 273.77 | 86.66 |
| 75 | 273,336.36 | 1,798.65 | 431.97 | 1,366.68 | 272,904.39 | 0.43 | 273.34 | 87.10 |
| 76 | 272,904.39 | 1,798.65 | 434.13 | 1,364.52 | 272,470.26 | 0.43 | 272.90 | 87.53 |
| 77 | 272,470.26 | 1,798.65 | 436.30 | 1,362.35 | 272,033.96 | 0.44 | 272.47 | 87.97 |
| 78 | 272,033.96 | 1,798.65 | 438.48 | 1,360.17 | 271,595.47 | 0.44 | 272.03 | 88.40 |
| 79 | 271,595.47 | 1,798.65 | 440.67 | 1,357.98 | 271,154.80 | 0.44 | 271.60 | 88.85 |
| 80 | 271,154.80 | 1,798.65 | 442.88 | 1,355.77 | 270,711.92 | 0.44 | 271.15 | 89.29 |
| 81 | 270,711.92 | 1,798.65 | 445.09 | 1,353.56 | 270,266.83 | 0.45 | 270.71 | 89.73 |
| 82 | 270,266.83 | 1,798.65 | 447.32 | 1,351.33 | 269,819.51 | 0.45 | 270.27 | 90.18 |
| 83 | 269,819.51 | 1,798.65 | 449.55 | 1,349.10 | 269,369.96 | 0.45 | 269.82 | 90.63 |
| 84 | 269,369.96 | 1,798.65 | 451.80 | 1,346.85 | 268,918.16 | 0.45 | 269.37 | 91.08 |
| 85 | 268,918.16 | 1,798.65 | 454.06 | 1,344.59 | 268,464.10 | 0.45 | 268.92 | 91.54 |
| 86 | 268,464.10 | 1,798.65 | 456.33 | 1,342.32 | 268,007.77 | 0.46 | 268.46 | 91.99 |
| 87 | 268,007.77 | 1,798.65 | 458.61 | 1,340.04 | 267,549.15 | 0.46 | 268.01 | 92.45 |
| 88 | 267,549.15 | 1,798.65 | 460.91 | 1,337.75 | 267,088.25 | 0.46 | 267.55 | 92.91 |
| 89 | 267,088.25 | 1,798.65 | 463.21 | 1,335.44 | 266,625.04 | 0.46 | 267.09 | 93.37 |
| 90 | 266,625.04 | 1,798.65 | 465.53 | 1,333.13 | 266,159.51 | 0.47 | 266.63 | 93.84 |
| 91 | 266,159.51 | 1,798.65 | 467.85 | 1,330.80 | 265,691.66 | 0.47 | 266.16 | 94.31 |
| 92 | 265,691.66 | 1,798.65 | 470.19 | 1,328.46 | 265,221.46 | 0.47 | 265.69 | 94.78 |
| 93 | 265,221.46 | 1,798.65 | 472.54 | 1,326.11 | 264,748.92 | 0.47 | 265.22 | 95.25 |
| 94 | 264,748.92 | 1,798.65 | 474.91 | 1,323.74 | 264,274.01 | 0.47 | 264.75 | 95.73 |
| 95 | 264,274.01 | 1,798.65 | 477.28 | 1,321.37 | 263,796.73 | 0.48 | 264.27 | 96.20 |
| 96 | 263,796.73 | 1,798.65 | 479.67 | 1,318.98 | 263,317.06 | 0.48 | 263.80 | 96.68 |
| 97 | 263,317.06 | 1,798.65 | 482.07 | 1,316.59 | 262,835.00 | 0.48 | 263.32 | 97.17 |
| 98 | 262,835.00 | 1,798.65 | 484.48 | 1,314.17 | 262,350.52 | 0.48 | 262.83 | 97.65 |
| 99 | 262,350.52 | 1,798.65 | 486.90 | 1,311.75 | 261,863.62 | 0.49 | 262.35 | 98.14 |
| 100 | 261,863.62 | 1,798.65 | 489.33 | 1,309.32 | 261,374.29 | 0.49 | 261.86 | 98.63 |
| 101 | 261,374.29 | 1,798.65 | 491.78 | 1,306.87 | 260,882.51 | 0.49 | 261.37 | 99.12 |
| 102 | 260,882.51 | 1,798.65 | 494.24 | 1,304.41 | 260,388.27 | 0.49 | 260.88 | 99.61 |
| 103 | 260,388.27 | 1,798.65 | 496.71 | 1,301.94 | 259,891.56 | 0.50 | 260.39 | 100.11 |
| 104 | 259,891.56 | 1,798.65 | 499.19 | 1,299.46 | 259,392.36 | 0.50 | 259.89 | 100.61 |
| 105 | 259,392.36 | 1,798.65 | 501.69 | 1,296.96 | 258,890.67 | 0.50 | 259.39 | 101.11 |
| 106 | 258,890.67 | 1,798.65 | 504.20 | 1,294.45 | 258,386.48 | 0.50 | 258.89 | 101.61 |
| 107 | 258,386.48 | 1,798.65 | 506.72 | 1,291.93 | 257,879.76 | 0.51 | 258.39 | 102.12 |
| 108 | 257,879.76 | 1,798.65 | 509.25 | 1,289.40 | 257,370.50 | 0.51 | 257.88 | 102.63 |
| 109 | 257,370.50 | 1,798.65 | 511.80 | 1,286.85 | 256,858.71 | 0.51 | 257.37 | 103.14 |
| 110 | 256,858.71 | 1,798.65 | 514.36 | 1,284.29 | 256,344.35 | 0.51 | 256.86 | 103.66 |
| 111 | 256,344.35 | 1,798.65 | 516.93 | 1,281.72 | 255,827.42 | 0.52 | 256.34 | 104.17 |
| 112 | 255,827.42 | 1,798.65 | 519.51 | 1,279.14 | 255,307.90 | 0.52 | 255.83 | 104.69 |
| 113 | 255,307.90 | 1,798.65 | 522.11 | 1,276.54 | 254,785.79 | 0.52 | 255.31 | 105.21 |
| 114 | 254,785.79 | 1,798.65 | 524.72 | 1,273.93 | 254,261.07 | 0.52 | 254.79 | 105.74 |
| 115 | 254,261.07 | 1,798.65 | 527.35 | 1,271.31 | 253,733.72 | 0.53 | 254.26 | 106.27 |
| 116 | 253,733.72 | 1,798.65 | 529.98 | 1,268.67 | 253,203.74 | 0.53 | 253.73 | 106.80 |
| 117 | 253,203.74 | 1,798.65 | 532.63 | 1,266.02 | 252,671.11 | 0.53 | 253.20 | 107.33 |
| 118 | 252,671.11 | 1,798.65 | 535.30 | 1,263.36 | 252,135.81 | 0.54 | 252.67 | 107.86 |
| 119 | 252,135.81 | 1,798.65 | 537.97 | 1,260.68 | 251,597.84 | 0.54 | 252.14 | 108.40 |
| 120 | 251,597.84 | 1,798.65 | 540.66 | 1,257.99 | 251,057.17 | 0.54 | 251.60 | 108.94 |
| 121 | 251,057.17 | 1,798.65 | 543.37 | 1,255.29 | 250,513.81 | 0.54 | 251.06 | 109.49 |
| 122 | 250,513.81 | 1,798.65 | 546.08 | 1,252.57 | 249,967.73 | 0.55 | 250.51 | 110.03 |
| 123 | 249,967.73 | 1,798.65 | 548.81 | 1,249.84 | 249,418.91 | 0.55 | 249.97 | 110.58 |
| 124 | 249,418.91 | 1,798.65 | 551.56 | 1,247.09 | 248,867.36 | 0.55 | 249.42 | 111.13 |
| 125 | 248,867.36 | 1,798.65 | 554.31 | 1,244.34 | 248,313.04 | 0.55 | 248.87 | 111.69 |
| 126 | 248,313.04 | 1,798.65 | 557.09 | 1,241.57 | 247,755.96 | 0.56 | 248.31 | 112.24 |
| 127 | 247,755.96 | 1,798.65 | 559.87 | 1,238.78 | 247,196.08 | 0.56 | 247.76 | 112.80 |
| 128 | 247,196.08 | 1,798.65 | 562.67 | 1,235.98 | 246,633.41 | 0.56 | 247.20 | 113.37 |
| 129 | 246,633.41 | 1,798.65 | 565.48 | 1,233.17 | 246,067.93 | 0.57 | 246.63 | 113.93 |
| 130 | 246,067.93 | 1,798.65 | 568.31 | 1,230.34 | 245,499.62 | 0.57 | 246.07 | 114.50 |
| 131 | 245,499.62 | 1,798.65 | 571.15 | 1,227.50 | 244,928.46 | 0.57 | 245.50 | 115.07 |
| 132 | 244,928.46 | 1,798.65 | 574.01 | 1,224.64 | 244,354.45 | 0.57 | 244.93 | 115.65 |
| 133 | 244,354.45 | 1,798.65 | 576.88 | 1,221.77 | 243,777.57 | 0.58 | 244.35 | 116.22 |
| 134 | 243,777.57 | 1,798.65 | 579.76 | 1,218.89 | 243,197.81 | 0.58 | 243.78 | 116.80 |
| 135 | 243,197.81 | 1,798.65 | 582.66 | 1,215.99 | 242,615.15 | 0.58 | 243.20 | 117.38 |
| 136 | 242,615.15 | 1,798.65 | 585.58 | 1,213.08 | 242,029.57 | 0.59 | 242.62 | 117.97 |
| 137 | 242,029.57 | 1,798.65 | 588.50 | 1,210.15 | 241,441.07 | 0.59 | 242.03 | 118.56 |
| 138 | 241,441.07 | 1,798.65 | 591.45 | 1,207.21 | 240,849.62 | 0.59 | 241.44 | 119.15 |
| 139 | 240,849.62 | 1,798.65 | 594.40 | 1,204.25 | 240,255.22 | 0.59 | 240.85 | 119.74 |
| 140 | 240,255.22 | 1,798.65 | 597.38 | 1,201.28 | 239,657.84 | 0.60 | 240.26 | 120.34 |
| 141 | 239,657.84 | 1,798.65 | 600.36 | 1,198.29 | 239,057.48 | 0.60 | 239.66 | 120.94 |
| 142 | 239,057.48 | 1,798.65 | 603.36 | 1,195.29 | 238,454.12 | 0.60 | 239.06 | 121.55 |
| 143 | 238,454.12 | 1,798.65 | 606.38 | 1,192.27 | 237,847.74 | 0.61 | 238.45 | 122.15 |
| 144 | 237,847.74 | 1,798.65 | 609.41 | 1,189.24 | 237,238.32 | 0.61 | 237.85 | 122.76 |
| 145 | 237,238.32 | 1,798.65 | 612.46 | 1,186.19 | 236,625.86 | 0.61 | 237.24 | 123.37 |
| 146 | 236,625.86 | 1,798.65 | 615.52 | 1,183.13 | 236,010.34 | 0.62 | 236.63 | 123.99 |
| 147 | 236,010.34 | 1,798.65 | 618.60 | 1,180.05 | 235,391.74 | 0.62 | 236.01 | 124.61 |
| 148 | 235,391.74 | 1,798.65 | 621.69 | 1,176.96 | 234,770.05 | 0.62 | 235.39 | 125.23 |
| 149 | 234,770.05 | 1,798.65 | 624.80 | 1,173.85 | 234,145.25 | 0.62 | 234.77 | 125.85 |
| 150 | 234,145.25 | 1,798.65 | 627.93 | 1,170.73 | 233,517.32 | 0.63 | 234.15 | 126.48 |
| 151 | 233,517.32 | 1,798.65 | 631.06 | 1,167.59 | 232,886.26 | 0.63 | 233.52 | 127.11 |
| 152 | 232,886.26 | 1,798.65 | 634.22 | 1,164.43 | 232,252.04 | 0.63 | 232.89 | 127.75 |
| 153 | 232,252.04 | 1,798.65 | 637.39 | 1,161.26 | 231,614.64 | 0.64 | 232.25 | 128.39 |
| 154 | 231,614.64 | 1,798.65 | 640.58 | 1,158.07 | 230,974.07 | 0.64 | 231.61 | 129.03 |
| 155 | 230,974.07 | 1,798.65 | 643.78 | 1,154.87 | 230,330.28 | 0.64 | 230.97 | 129.67 |
| 156 | 230,330.28 | 1,798.65 | 647.00 | 1,151.65 | 229,683.28 | 0.65 | 230.33 | 130.32 |
| 157 | 229,683.28 | 1,798.65 | 650.24 | 1,148.42 | 229,033.05 | 0.65 | 229.68 | 130.97 |
| 158 | 229,033.05 | 1,798.65 | 653.49 | 1,145.17 | 228,379.56 | 0.65 | 229.03 | 131.62 |
| 159 | 228,379.56 | 1,798.65 | 656.75 | 1,141.90 | 227,722.81 | 0.66 | 228.38 | 132.28 |
| 160 | 227,722.81 | 1,798.65 | 660.04 | 1,138.61 | 227,062.77 | 0.66 | 227.72 | 132.94 |
| 161 | 227,062.77 | 1,798.65 | 663.34 | 1,135.31 | 226,399.43 | 0.66 | 227.06 | 133.60 |
| 162 | 226,399.43 | 1,798.65 | 666.65 | 1,132.00 | 225,732.78 | 0.67 | 226.40 | 134.27 |
| 163 | 225,732.78 | 1,798.65 | 669.99 | 1,128.66 | 225,062.79 | 0.67 | 225.73 | 134.94 |
| 164 | 225,062.79 | 1,798.65 | 673.34 | 1,125.31 | 224,389.45 | 0.67 | 225.06 | 135.61 |
| 165 | 224,389.45 | 1,798.65 | 676.70 | 1,121.95 | 223,712.75 | 0.68 | 224.39 | 136.29 |
| 166 | 223,712.75 | 1,798.65 | 680.09 | 1,118.56 | 223,032.66 | 0.68 | 223.71 | 136.97 |
| 167 | 223,032.66 | 1,798.65 | 683.49 | 1,115.16 | 222,349.17 | 0.68 | 223.03 | 137.65 |
| 168 | 222,349.17 | 1,798.65 | 686.91 | 1,111.75 | 221,662.27 | 0.69 | 222.35 | 138.34 |
| 169 | 221,662.27 | 1,798.65 | 690.34 | 1,108.31 | 220,971.93 | 0.69 | 221.66 | 139.03 |
| 170 | 220,971.93 | 1,798.65 | 693.79 | 1,104.86 | 220,278.14 | 0.69 | 220.97 | 139.72 |
| 171 | 220,278.14 | 1,798.65 | 697.26 | 1,101.39 | 219,580.88 | 0.70 | 220.28 | 140.42 |
| 172 | 219,580.88 | 1,798.65 | 700.75 | 1,097.90 | 218,880.13 | 0.70 | 219.58 | 141.12 |
| 173 | 218,880.13 | 1,798.65 | 704.25 | 1,094.40 | 218,175.88 | 0.70 | 218.88 | 141.82 |
| 174 | 218,175.88 | 1,798.65 | 707.77 | 1,090.88 | 217,468.10 | 0.71 | 218.18 | 142.53 |
| 175 | 217,468.10 | 1,798.65 | 711.31 | 1,087.34 | 216,756.79 | 0.71 | 217.47 | 143.24 |
| 176 | 216,756.79 | 1,798.65 | 714.87 | 1,083.78 | 216,041.93 | 0.71 | 216.76 | 143.96 |
| 177 | 216,041.93 | 1,798.65 | 718.44 | 1,080.21 | 215,323.48 | 0.72 | 216.04 | 144.68 |
| 178 | 215,323.48 | 1,798.65 | 722.03 | 1,076.62 | 214,601.45 | 0.72 | 215.32 | 145.40 |
| 179 | 214,601.45 | 1,798.65 | 725.64 | 1,073.01 | 213,875.81 | 0.73 | 214.60 | 146.12 |
| 180 | 213,875.81 | 1,798.65 | 729.27 | 1,069.38 | 213,146.53 | 0.73 | 213.88 | 146.85 |
| 181 | 213,146.53 | 1,798.65 | 732.92 | 1,065.73 | 212,413.61 | 0.73 | 213.15 | 147.59 |
| 182 | 212,413.61 | 1,798.65 | 736.58 | 1,062.07 | 211,677.03 | 0.74 | 212.41 | 148.32 |
| 183 | 211,677.03 | 1,798.65 | 740.27 | 1,058.39 | 210,936.76 | 0.74 | 211.68 | 149.06 |
| 184 | 210,936.76 | 1,798.65 | 743.97 | 1,054.68 | 210,192.80 | 0.74 | 210.94 | 149.81 |
| 185 | 210,192.80 | 1,798.65 | 747.69 | 1,050.96 | 209,445.11 | 0.75 | 210.19 | 150.55 |
| 186 | 209,445.11 | 1,798.65 | 751.43 | 1,047.23 | 208,693.68 | 0.75 | 209.45 | 151.31 |
| 187 | 208,693.68 | 1,798.65 | 755.18 | 1,043.47 | 207,938.50 | 0.76 | 208.69 | 152.06 |
| 188 | 207,938.50 | 1,798.65 | 758.96 | 1,039.69 | 207,179.54 | 0.76 | 207.94 | 152.82 |
| 189 | 207,179.54 | 1,798.65 | 762.75 | 1,035.90 | 206,416.79 | 0.76 | 207.18 | 153.58 |
| 190 | 206,416.79 | 1,798.65 | 766.57 | 1,032.08 | 205,650.22 | 0.77 | 206.42 | 154.35 |
| 191 | 205,650.22 | 1,798.65 | 770.40 | 1,028.25 | 204,879.82 | 0.77 | 205.65 | 155.12 |
| 192 | 204,879.82 | 1,798.65 | 774.25 | 1,024.40 | 204,105.57 | 0.77 | 204.88 | 155.89 |
| 193 | 204,105.57 | 1,798.65 | 778.12 | 1,020.53 | 203,327.44 | 0.78 | 204.11 | 156.67 |
| 194 | 203,327.44 | 1,798.65 | 782.01 | 1,016.64 | 202,545.43 | 0.78 | 203.33 | 157.45 |
| 195 | 202,545.43 | 1,798.65 | 785.92 | 1,012.73 | 201,759.50 | 0.79 | 202.55 | 158.24 |
| 196 | 201,759.50 | 1,798.65 | 789.85 | 1,008.80 | 200,969.65 | 0.79 | 201.76 | 159.03 |
| 197 | 200,969.65 | 1,798.65 | 793.80 | 1,004.85 | 200,175.85 | 0.79 | 200.97 | 159.82 |
| 198 | 200,175.85 | 1,798.65 | 797.77 | 1,000.88 | 199,378.07 | 0.80 | 200.18 | 160.62 |
| 199 | 199,378.07 | 1,798.65 | 801.76 | 996.89 | 198,576.31 | 0.80 | 199.38 | 161.42 |
| 200 | 198,576.31 | 1,798.65 | 805.77 | 992.88 | 197,770.54 | 0.81 | 198.58 | 162.23 |
| 201 | 197,770.54 | 1,798.65 | 809.80 | 988.85 | 196,960.74 | 0.81 | 197.77 | 163.04 |
| 202 | 196,960.74 | 1,798.65 | 813.85 | 984.80 | 196,146.90 | 0.81 | 196.96 | 163.85 |
| 203 | 196,146.90 | 1,798.65 | 817.92 | 980.73 | 195,328.98 | 0.82 | 196.15 | 164.67 |
| 204 | 195,328.98 | 1,798.65 | 822.01 | 976.64 | 194,506.97 | 0.82 | 195.33 | 165.49 |
| 205 | 194,506.97 | 1,798.65 | 826.12 | 972.53 | 193,680.86 | 0.83 | 194.51 | 166.32 |
| 206 | 193,680.86 | 1,798.65 | 830.25 | 968.40 | 192,850.61 | 0.83 | 193.68 | 167.15 |
| 207 | 192,850.61 | 1,798.65 | 834.40 | 964.25 | 192,016.21 | 0.83 | 192.85 | 167.98 |
| 208 | 192,016.21 | 1,798.65 | 838.57 | 960.08 | 191,177.64 | 0.84 | 192.02 | 168.82 |
| 209 | 191,177.64 | 1,798.65 | 842.76 | 955.89 | 190,334.88 | 0.84 | 191.18 | 169.67 |
| 210 | 190,334.88 | 1,798.65 | 846.98 | 951.67 | 189,487.90 | 0.85 | 190.33 | 170.51 |
| 211 | 189,487.90 | 1,798.65 | 851.21 | 947.44 | 188,636.69 | 0.85 | 189.49 | 171.36 |
| 212 | 188,636.69 | 1,798.65 | 855.47 | 943.18 | 187,781.22 | 0.86 | 188.64 | 172.22 |
| 213 | 187,781.22 | 1,798.65 | 859.75 | 938.91 | 186,921.47 | 0.86 | 187.78 | 173.08 |
| 214 | 186,921.47 | 1,798.65 | 864.04 | 934.61 | 186,057.43 | 0.86 | 186.92 | 173.94 |
| 215 | 186,057.43 | 1,798.65 | 868.36 | 930.29 | 185,189.06 | 0.87 | 186.06 | 174.81 |
| 216 | 185,189.06 | 1,798.65 | 872.71 | 925.95 | 184,316.36 | 0.87 | 185.19 | 175.68 |
| 217 | 184,316.36 | 1,798.65 | 877.07 | 921.58 | 183,439.29 | 0.88 | 184.32 | 176.56 |
| 218 | 183,439.29 | 1,798.65 | 881.46 | 917.20 | 182,557.83 | 0.88 | 183.44 | 177.44 |
| 219 | 182,557.83 | 1,798.65 | 885.86 | 912.79 | 181,671.97 | 0.89 | 182.56 | 178.33 |
| 220 | 181,671.97 | 1,798.65 | 890.29 | 908.36 | 180,781.68 | 0.89 | 181.67 | 179.22 |
| 221 | 180,781.68 | 1,798.65 | 894.74 | 903.91 | 179,886.94 | 0.89 | 180.78 | 180.11 |
| 222 | 179,886.94 | 1,798.65 | 899.22 | 899.43 | 178,987.72 | 0.90 | 179.89 | 181.01 |
| 223 | 178,987.72 | 1,798.65 | 903.71 | 894.94 | 178,084.01 | 0.90 | 178.99 | 181.92 |
| 224 | 178,084.01 | 1,798.65 | 908.23 | 890.42 | 177,175.77 | 0.91 | 178.08 | 182.82 |
| 225 | 177,175.77 | 1,798.65 | 912.77 | 885.88 | 176,263.00 | 0.91 | 177.18 | 183.74 |
| 226 | 176,263.00 | 1,798.65 | 917.34 | 881.32 | 175,345.67 | 0.92 | 176.26 | 184.65 |
| 227 | 175,345.67 | 1,798.65 | 921.92 | 876.73 | 174,423.74 | 0.92 | 175.35 | 185.58 |
| 228 | 174,423.74 | 1,798.65 | 926.53 | 872.12 | 173,497.21 | 0.93 | 174.42 | 186.50 |
| 229 | 173,497.21 | 1,798.65 | 931.17 | 867.49 | 172,566.04 | 0.93 | 173.50 | 187.43 |
| 230 | 172,566.04 | 1,798.65 | 935.82 | 862.83 | 171,630.22 | 0.94 | 172.57 | 188.37 |
| 231 | 171,630.22 | 1,798.65 | 940.50 | 858.15 | 170,689.72 | 0.94 | 171.63 | 189.31 |
| 232 | 170,689.72 | 1,798.65 | 945.20 | 853.45 | 169,744.52 | 0.95 | 170.69 | 190.26 |
| 233 | 169,744.52 | 1,798.65 | 949.93 | 848.72 | 168,794.59 | 0.95 | 169.74 | 191.21 |
| 234 | 168,794.59 | 1,798.65 | 954.68 | 843.97 | 167,839.91 | 0.95 | 168.79 | 192.16 |
| 235 | 167,839.91 | 1,798.65 | 959.45 | 839.20 | 166,880.46 | 0.96 | 167.84 | 193.12 |
| 236 | 166,880.46 | 1,798.65 | 964.25 | 834.40 | 165,916.21 | 0.96 | 166.88 | 194.08 |
| 237 | 165,916.21 | 1,798.65 | 969.07 | 829.58 | 164,947.14 | 0.97 | 165.92 | 195.05 |
| 238 | 164,947.14 | 1,798.65 | 973.92 | 824.74 | 163,973.22 | 0.97 | 164.95 | 196.03 |
| 239 | 163,973.22 | 1,798.65 | 978.79 | 819.87 | 162,994.44 | 0.98 | 163.97 | 197.01 |
| 240 | 162,994.44 | 1,798.65 | 983.68 | 814.97 | 162,010.76 | 0.98 | 162.99 | 197.99 |
| 241 | 162,010.76 | 1,798.65 | 988.60 | 810.05 | 161,022.16 | 0.99 | 162.01 | 198.98 |
| 242 | 161,022.16 | 1,798.65 | 993.54 | 805.11 | 160,028.62 | 0.99 | 161.02 | 199.97 |
| 243 | 160,028.62 | 1,798.65 | 998.51 | 800.14 | 159,030.11 | 1.00 | 160.03 | 200.97 |
| 244 | 159,030.11 | 1,798.65 | 1,003.50 | 795.15 | 158,026.61 | 1.00 | 159.03 | 201.97 |
| 245 | 158,026.61 | 1,798.65 | 1,008.52 | 790.13 | 157,018.09 | 1.01 | 158.03 | 202.98 |
| 246 | 157,018.09 | 1,798.65 | 1,013.56 | 785.09 | 156,004.53 | 1.01 | 157.02 | 204.00 |
| 247 | 156,004.53 | 1,798.65 | 1,018.63 | 780.02 | 154,985.90 | 1.02 | 156.00 | 205.01 |
| 248 | 154,985.90 | 1,798.65 | 1,023.72 | 774.93 | 153,962.18 | 1.02 | 154.99 | 206.04 |
| 249 | 153,962.18 | 1,798.65 | 1,028.84 | 769.81 | 152,933.34 | 1.03 | 153.96 | 207.07 |
| 250 | 152,933.34 | 1,798.65 | 1,033.98 | 764.67 | 151,899.35 | 1.03 | 152.93 | 208.10 |
| 251 | 151,899.35 | 1,798.65 | 1,039.15 | 759.50 | 150,860.20 | 1.04 | 151.90 | 209.14 |
| 252 | 150,860.20 | 1,798.65 | 1,044.35 | 754.30 | 149,815.85 | 1.04 | 150.86 | 210.18 |
| 253 | 149,815.85 | 1,798.65 | 1,049.57 | 749.08 | 148,766.28 | 1.05 | 149.82 | 211.23 |
| 254 | 148,766.28 | 1,798.65 | 1,054.82 | 743.83 | 147,711.46 | 1.05 | 148.77 | 212.29 |
| 255 | 147,711.46 | 1,798.65 | 1,060.09 | 738.56 | 146,651.36 | 1.06 | 147.71 | 213.35 |
| 256 | 146,651.36 | 1,798.65 | 1,065.39 | 733.26 | 145,585.97 | 1.07 | 146.65 | 214.41 |
| 257 | 145,585.97 | 1,798.65 | 1,070.72 | 727.93 | 144,515.25 | 1.07 | 145.59 | 215.48 |
| 258 | 144,515.25 | 1,798.65 | 1,076.08 | 722.58 | 143,439.17 | 1.08 | 144.52 | 216.56 |
| 259 | 143,439.17 | 1,798.65 | 1,081.46 | 717.20 | 142,357.71 | 1.08 | 143.44 | 217.64 |
| 260 | 142,357.71 | 1,798.65 | 1,086.86 | 711.79 | 141,270.85 | 1.09 | 142.36 | 218.73 |
| 261 | 141,270.85 | 1,798.65 | 1,092.30 | 706.35 | 140,178.55 | 1.09 | 141.27 | 219.82 |
| 262 | 140,178.55 | 1,798.65 | 1,097.76 | 700.89 | 139,080.80 | 1.10 | 140.18 | 220.92 |
| 263 | 139,080.80 | 1,798.65 | 1,103.25 | 695.40 | 137,977.55 | 1.10 | 139.08 | 222.02 |
| 264 | 137,977.55 | 1,798.65 | 1,108.76 | 689.89 | 136,868.78 | 1.11 | 137.98 | 223.13 |
| 265 | 136,868.78 | 1,798.65 | 1,114.31 | 684.34 | 135,754.48 | 1.11 | 136.87 | 224.25 |
| 266 | 135,754.48 | 1,798.65 | 1,119.88 | 678.77 | 134,634.60 | 1.12 | 135.75 | 225.37 |
| 267 | 134,634.60 | 1,798.65 | 1,125.48 | 673.17 | 133,509.12 | 1.13 | 134.63 | 226.49 |
| 268 | 133,509.12 | 1,798.65 | 1,131.11 | 667.55 | 132,378.01 | 1.13 | 133.51 | 227.62 |
| 269 | 132,378.01 | 1,798.65 | 1,136.76 | 661.89 | 131,241.25 | 1.14 | 132.38 | 228.76 |
| 270 | 131,241.25 | 1,798.65 | 1,142.45 | 656.21 | 130,098.81 | 1.14 | 131.24 | 229.90 |
| 271 | 130,098.81 | 1,798.65 | 1,148.16 | 650.49 | 128,950.65 | 1.15 | 130.10 | 231.05 |
| 272 | 128,950.65 | 1,798.65 | 1,153.90 | 644.75 | 127,796.75 | 1.15 | 128.95 | 232.20 |
| 273 | 127,796.75 | 1,798.65 | 1,159.67 | 638.98 | 126,637.08 | 1.16 | 127.80 | 233.36 |
| 274 | 126,637.08 | 1,798.65 | 1,165.47 | 633.19 | 125,471.62 | 1.17 | 126.64 | 234.53 |
| 275 | 125,471.62 | 1,798.65 | 1,171.29 | 627.36 | 124,300.32 | 1.17 | 125.47 | 235.70 |
| 276 | 124,300.32 | 1,798.65 | 1,177.15 | 621.50 | 123,123.17 | 1.18 | 124.30 | 236.88 |
| 277 | 123,123.17 | 1,798.65 | 1,183.04 | 615.62 | 121,940.14 | 1.18 | 123.12 | 238.06 |
| 278 | 121,940.14 | 1,798.65 | 1,188.95 | 609.70 | 120,751.19 | 1.19 | 121.94 | 239.25 |
| 279 | 120,751.19 | 1,798.65 | 1,194.90 | 603.76 | 119,556.29 | 1.19 | 120.75 | 240.44 |
| 280 | 119,556.29 | 1,798.65 | 1,200.87 | 597.78 | 118,355.42 | 1.20 | 119.56 | 241.64 |
| 281 | 118,355.42 | 1,798.65 | 1,206.87 | 591.78 | 117,148.55 | 1.21 | 118.36 | 242.85 |
| 282 | 117,148.55 | 1,798.65 | 1,212.91 | 585.74 | 115,935.64 | 1.21 | 117.15 | 244.06 |
| 283 | 115,935.64 | 1,798.65 | 1,218.97 | 579.68 | 114,716.66 | 1.22 | 115.94 | 245.28 |
| 284 | 114,716.66 | 1,798.65 | 1,225.07 | 573.58 | 113,491.60 | 1.23 | 114.72 | 246.51 |
| 285 | 113,491.60 | 1,798.65 | 1,231.19 | 567.46 | 112,260.40 | 1.23 | 113.49 | 247.74 |
| 286 | 112,260.40 | 1,798.65 | 1,237.35 | 561.30 | 111,023.05 | 1.24 | 112.26 | 248.98 |
| 287 | 111,023.05 | 1,798.65 | 1,243.54 | 555.12 | 109,779.52 | 1.24 | 111.02 | 250.22 |
| 288 | 109,779.52 | 1,798.65 | 1,249.75 | 548.90 | 108,529.76 | 1.25 | 109.78 | 251.47 |
| 289 | 108,529.76 | 1,798.65 | 1,256.00 | 542.65 | 107,273.76 | 1.26 | 108.53 | 252.73 |
| 290 | 107,273.76 | 1,798.65 | 1,262.28 | 536.37 | 106,011.48 | 1.26 | 107.27 | 253.99 |
| 291 | 106,011.48 | 1,798.65 | 1,268.59 | 530.06 | 104,742.88 | 1.27 | 106.01 | 255.26 |
| 292 | 104,742.88 | 1,798.65 | 1,274.94 | 523.71 | 103,467.94 | 1.27 | 104.74 | 256.53 |
| 293 | 103,467.94 | 1,798.65 | 1,281.31 | 517.34 | 102,186.63 | 1.28 | 103.47 | 257.81 |
| 294 | 102,186.63 | 1,798.65 | 1,287.72 | 510.93 | 100,898.91 | 1.29 | 102.19 | 259.10 |
| 295 | 100,898.91 | 1,798.65 | 1,294.16 | 504.49 | 99,604.76 | 1.29 | 100.90 | 260.40 |
| 296 | 99,604.76 | 1,798.65 | 1,300.63 | 498.02 | 98,304.13 | 1.30 | 99.60 | 261.70 |
| 297 | 98,304.13 | 1,798.65 | 1,307.13 | 491.52 | 96,997.00 | 1.31 | 98.30 | 263.00 |
| 298 | 96,997.00 | 1,798.65 | 1,313.67 | 484.98 | 95,683.33 | 1.31 | 97.00 | 264.32 |
| 299 | 95,683.33 | 1,798.65 | 1,320.23 | 478.42 | 94,363.10 | 1.32 | 95.68 | 265.64 |
| 300 | 94,363.10 | 1,798.65 | 1,326.84 | 471.82 | 93,036.26 | 1.33 | 94.36 | 266.96 |
| 301 | 93,036.26 | 1,798.65 | 1,333.47 | 465.18 | 91,702.79 | 1.33 | 93.04 | 268.30 |
| 302 | 91,702.79 | 1,798.65 | 1,340.14 | 458.51 | 90,362.65 | 1.34 | 91.70 | 269.64 |
| 303 | 90,362.65 | 1,798.65 | 1,346.84 | 451.81 | 89,015.82 | 1.35 | 90.36 | 270.98 |
| 304 | 89,015.82 | 1,798.65 | 1,353.57 | 445.08 | 87,662.24 | 1.35 | 89.02 | 272.34 |
| 305 | 87,662.24 | 1,798.65 | 1,360.34 | 438.31 | 86,301.90 | 1.36 | 87.66 | 273.70 |
| 306 | 86,301.90 | 1,798.65 | 1,367.14 | 431.51 | 84,934.76 | 1.37 | 86.30 | 275.07 |
| 307 | 84,934.76 | 1,798.65 | 1,373.98 | 424.67 | 83,560.78 | 1.37 | 84.93 | 276.44 |
| 308 | 83,560.78 | 1,798.65 | 1,380.85 | 417.80 | 82,179.93 | 1.38 | 83.56 | 277.82 |
| 309 | 82,179.93 | 1,798.65 | 1,387.75 | 410.90 | 80,792.18 | 1.39 | 82.18 | 279.21 |
| 310 | 80,792.18 | 1,798.65 | 1,394.69 | 403.96 | 79,397.49 | 1.39 | 80.79 | 280.60 |
| 311 | 79,397.49 | 1,798.65 | 1,401.66 | 396.99 | 77,995.83 | 1.40 | 79.40 | 282.00 |
| 312 | 77,995.83 | 1,798.65 | 1,408.67 | 389.98 | 76,587.16 | 1.41 | 78.00 | 283.41 |
| 313 | 76,587.16 | 1,798.65 | 1,415.72 | 382.94 | 75,171.44 | 1.42 | 76.59 | 284.83 |
| 314 | 75,171.44 | 1,798.65 | 1,422.79 | 375.86 | 73,748.65 | 1.42 | 75.17 | 286.25 |
| 315 | 73,748.65 | 1,798.65 | 1,429.91 | 368.74 | 72,318.74 | 1.43 | 73.75 | 287.68 |
| 316 | 72,318.74 | 1,798.65 | 1,437.06 | 361.59 | 70,881.68 | 1.44 | 72.32 | 289.12 |
| 317 | 70,881.68 | 1,798.65 | 1,444.24 | 354.41 | 69,437.44 | 1.44 | 70.88 | 290.56 |
| 318 | 69,437.44 | 1,798.65 | 1,451.46 | 347.19 | 67,985.97 | 1.45 | 69.44 | 292.01 |
| 319 | 67,985.97 | 1,798.65 | 1,458.72 | 339.93 | 66,527.25 | 1.46 | 67.99 | 293.47 |
| 320 | 66,527.25 | 1,798.65 | 1,466.02 | 332.64 | 65,061.23 | 1.47 | 66.53 | 294.94 |
| 321 | 65,061.23 | 1,798.65 | 1,473.35 | 325.31 | 63,587.89 | 1.47 | 65.06 | 296.41 |
| 322 | 63,587.89 | 1,798.65 | 1,480.71 | 317.94 | 62,107.18 | 1.48 | 63.59 | 297.89 |
| 323 | 62,107.18 | 1,798.65 | 1,488.12 | 310.54 | 60,619.06 | 1.49 | 62.11 | 299.38 |
| 324 | 60,619.06 | 1,798.65 | 1,495.56 | 303.10 | 59,123.51 | 1.50 | 60.62 | 300.88 |
| 325 | 59,123.51 | 1,798.65 | 1,503.03 | 295.62 | 57,620.47 | 1.50 | 59.12 | 302.38 |
| 326 | 57,620.47 | 1,798.65 | 1,510.55 | 288.10 | 56,109.92 | 1.51 | 57.62 | 303.89 |
| 327 | 56,109.92 | 1,798.65 | 1,518.10 | 280.55 | 54,591.82 | 1.52 | 56.11 | 305.41 |
| 328 | 54,591.82 | 1,798.65 | 1,525.69 | 272.96 | 53,066.13 | 1.53 | 54.59 | 306.93 |
| 329 | 53,066.13 | 1,798.65 | 1,533.32 | 265.33 | 51,532.81 | 1.53 | 53.07 | 308.47 |
| 330 | 51,532.81 | 1,798.65 | 1,540.99 | 257.66 | 49,991.82 | 1.54 | 51.53 | 310.01 |
| 331 | 49,991.82 | 1,798.65 | 1,548.69 | 249.96 | 48,443.13 | 1.55 | 49.99 | 311.56 |
| 332 | 48,443.13 | 1,798.65 | 1,556.44 | 242.22 | 46,886.69 | 1.56 | 48.44 | 313.11 |
| 333 | 46,886.69 | 1,798.65 | 1,564.22 | 234.43 | 45,322.47 | 1.56 | 46.89 | 314.68 |
| 334 | 45,322.47 | 1,798.65 | 1,572.04 | 226.61 | 43,750.43 | 1.57 | 45.32 | 316.25 |
| 335 | 43,750.43 | 1,798.65 | 1,579.90 | 218.75 | 42,170.53 | 1.58 | 43.75 | 317.83 |
| 336 | 42,170.53 | 1,798.65 | 1,587.80 | 210.85 | 40,582.73 | 1.59 | 42.17 | 319.42 |
| 337 | 40,582.73 | 1,798.65 | 1,595.74 | 202.91 | 38,987.00 | 1.60 | 40.58 | 321.01 |
| 338 | 38,987.00 | 1,798.65 | 1,603.72 | 194.93 | 37,383.28 | 1.60 | 38.99 | 322.62 |
| 339 | 37,383.28 | 1,798.65 | 1,611.74 | 186.92 | 35,771.55 | 1.61 | 37.38 | 324.23 |
| 340 | 35,771.55 | 1,798.65 | 1,619.79 | 178.86 | 34,151.75 | 1.62 | 35.77 | 325.85 |
| 341 | 34,151.75 | 1,798.65 | 1,627.89 | 170.76 | 32,523.86 | 1.63 | 34.15 | 327.48 |
| 342 | 32,523.86 | 1,798.65 | 1,636.03 | 162.62 | 30,887.83 | 1.64 | 32.52 | 329.11 |
| 343 | 30,887.83 | 1,798.65 | 1,644.21 | 154.44 | 29,243.61 | 1.64 | 30.89 | 330.76 |
| 344 | 29,243.61 | 1,798.65 | 1,652.43 | 146.22 | 27,591.18 | 1.65 | 29.24 | 332.41 |
| 345 | 27,591.18 | 1,798.65 | 1,660.70 | 137.96 | 25,930.48 | 1.66 | 27.59 | 334.07 |
| 346 | 25,930.48 | 1,798.65 | 1,669.00 | 129.65 | 24,261.49 | 1.67 | 25.93 | 335.74 |
| 347 | 24,261.49 | 1,798.65 | 1,677.34 | 121.31 | 22,584.14 | 1.68 | 24.26 | 337.42 |
| 348 | 22,584.14 | 1,798.65 | 1,685.73 | 112.92 | 20,898.41 | 1.69 | 22.58 | 339.10 |
| 349 | 20,898.41 | 1,798.65 | 1,694.16 | 104.49 | 19,204.25 | 1.69 | 20.90 | 340.80 |
| 350 | 19,204.25 | 1,798.65 | 1,702.63 | 96.02 | 17,501.62 | 1.70 | 19.20 | 342.50 |
| 351 | 17,501.62 | 1,798.65 | 1,711.14 | 87.51 | 15,790.48 | 1.71 | 17.50 | 344.21 |
| 352 | 15,790.48 | 1,798.65 | 1,719.70 | 78.95 | 14,070.78 | 1.72 | 15.79 | 345.93 |
| 353 | 14,070.78 | 1,798.65 | 1,728.30 | 70.35 | 12,342.48 | 1.73 | 14.07 | 347.66 |
| 354 | 12,342.48 | 1,798.65 | 1,736.94 | 61.71 | 10,605.54 | 1.74 | 12.34 | 349.39 |
| 355 | 10,605.54 | 1,798.65 | 1,745.62 | 53.03 | 8,859.92 | 1.75 | 10.61 | 351.14 |
| 356 | 8,859.92 | 1,798.65 | 1,754.35 | 44.30 | 7,105.57 | 1.75 | 8.86 | 352.89 |
| 357 | 7,105.57 | 1,798.65 | 1,763.12 | 35.53 | 5,342.44 | 1.76 | 7.11 | 354.66 |
| 358 | 5,342.44 | 1,798.65 | 1,771.94 | 26.71 | 3,570.50 | 1.77 | 5.34 | 356.43 |
| 359 | 3,570.50 | 1,798.65 | 1,780.80 | 17.85 | 1,789.70 | 1.78 | 3.57 | 358.21 |
| 360 | 1,789.70 | 1,798.65 | 1,780.75 | 8.95 | 0.00 | 1.78 | 1.79 | 359.99 |

As already said, the system has a penalty mechanism, with the transferring of the quota(s) or fractions of the same from the customer's account to bank's one as penalty for the lack of payment of at least one monthly installment. The value of quota transferred is calculated on the interest part of the unpaid installment, or, alternatively, with another counter-value agreed upon by the bank and customer which can also include a part of the principal part of the installment. The non-payment of one or more installments implies an extension of the duration of repurchase plan and an increase of the remaining quotas to be repurchased.

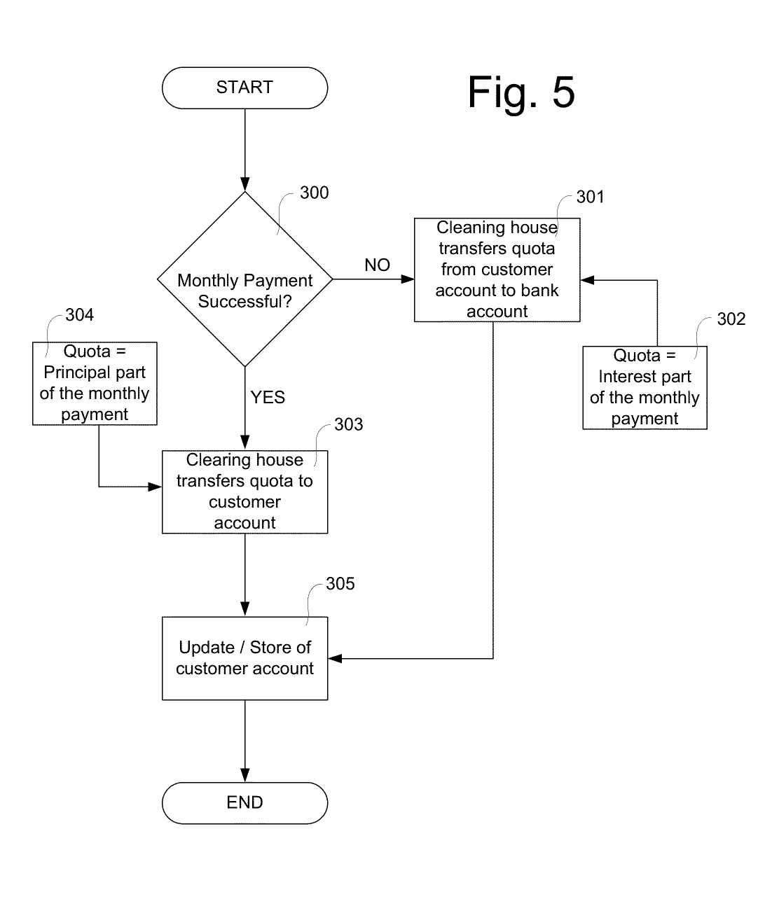

In FIG. 5 indicates the block scheme on which is based the process that each month determines the transferring of quota from bank to customer and vice-versa, performed by the clearing house on the instruction from the bank. After a payment request to the customer, the computerized bank system verifies (300) if the payment was done, in this case, it sends a message to the Clearing House subsystem (12) to transfer quota or fraction of quotas from the bank account to the customer account, where the quota assigned (304) is equal to the principal part of the monthly installment. In case the payment from customer was not performed, the computerized bank system asks to the clearing house (301) to transfer quotas or fraction of them from the customer's account to the account of the bank. In this case, the value of quota (302) is equal to the interest part of the installment unpaid. In both cases the transaction is stored into the Shares subsystem (23), with both the bank account, and customer bank account, updated after the transaction.

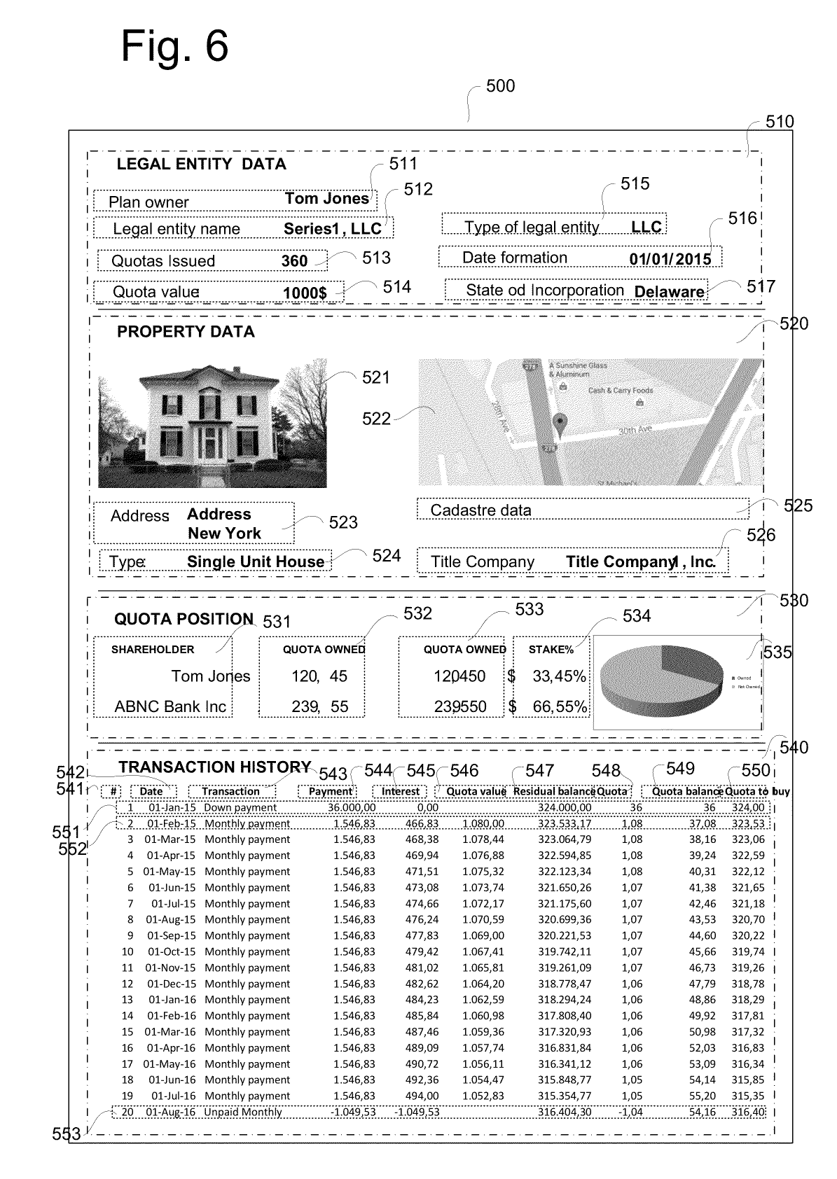

In FIG. 6 is illustrated a repurchase plan as it could appears on a computer screen output or as a printed report, obtained extracting data via a SQL query from different database of the system. The report (500) is made of four sections. The first section (510) shows data about the legal entity and data coming from the Legal Entity subsystem (24). In 511 is showed the plan owner (customer), with the 512 the legal entity name; in 513, the number of quotas issued and in 514 their value. In 515 is indicated the type of legal entity (LLC, Series LLC or Joint Stock Company), the date of formation (516) and the state of incorporation (517). The second section (520) regards property data where in 521 a photo of the property is showed, with a map having the property indicated (522), with 523 is indicated the property address and in 524 the type of property. In 525 are indicated (not showed) the cadastral data and in 526 the title company used to keep title record for this property. The data from the section 520 coming from the Real Estate subsystem (28) database.

The third section (530) shows the data regarding the quota position for each owners of the quota (531), usually the bank and a customer, the quota owned respectively (532), the value (533) and the percent they owned (534) using a pie graph that shows the holdings for each quota owner. This section is populated from data calculated from the Shares subsystem (23).

In the fourth section (540) is showed a transaction history, stored into the Plan subsystem (11). In the column 541 is indicated an id progressive number for each plan and for each transaction. The column 542 is related to the date of the transaction, while the description of the transaction is indicated in column 543. In column 544 is indicated the payment amount, with the separation of interest (545) and the quota value (546) for the transaction. In 547 is indicated the residual balance of the plan to be repurchased, in 528 the quota credited or debited in the transaction considered, with the balance of quota accumulated in 549 and the residual quota balance in 550.

In particular are considered the transactions indicated in 551, 552 and 553, as the most common. Transaction 551 is for the initial down payment for an amount of $ 36.000 with 36 quota credited. Transaction 552 is the monthly payment made by the customer to the bank. The transaction 553 indicates the case of a non payment of the monthly installment. In this case, the payment (544) is negative, with an interest (545) only debited, and an increase of the amounts of column 547 and 550, with a decrease of column 549, for the effect of the quota not accumulated due the lack of payment, for the effect of the procedure illustrated in FIG. 5.

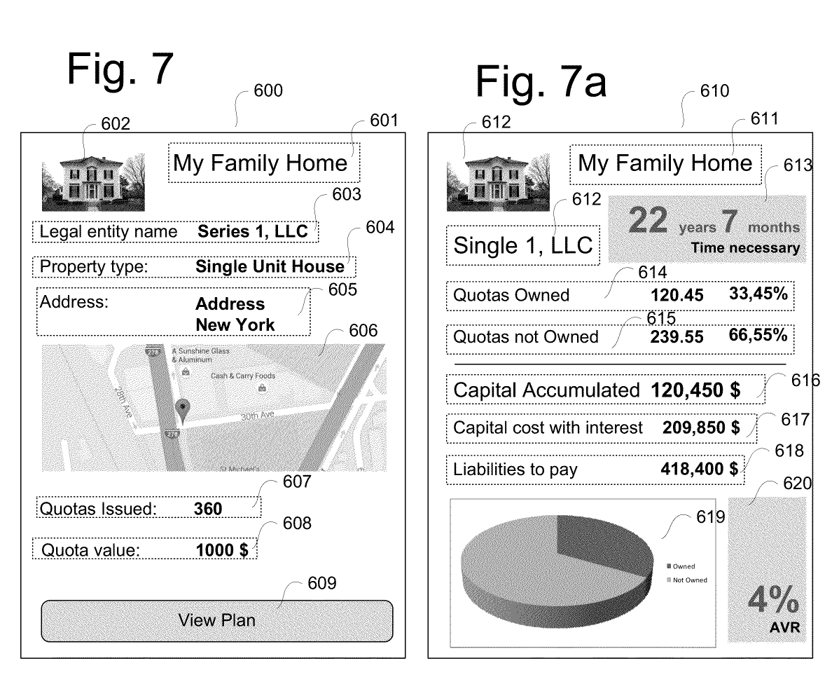

In FIGS. 7 and 7a is showed the user interface of the customer account with information displayed on a smartphone or a tablet using an “app”. Naturally these two screenshots are representative, in showing the information regarding the status of the repurchase plan. They can be made with a different design and data without loss of efficacy under the use of this invention. As well, these two screenshots could be part of the “app” that many banks give to their customers to make online banking operations. The first screenshot 600 is based on data coming from different databases. The title 601 is the name of the property assigned by the customer, a photo (602) is showed, with the name of legal entity (603), type of property (604) and address (605) with a map indicating the property based on the GPS position of the property. Additionally is showed the quota issued (607) for the legal entity, and the unitary value (608). The button 609 allows access to screenshot 610. Here the information are 613, where is highlighted the remaining time in years and months to purchase all the quotas or to complete the repurchase plan. In this way is visible at a first glance the residual time and this may be an incentive to complete the plan. In 614 are well marked the quotas owned and not owned (615) with indicating the percentage for each case. In 616 is highlighted the capital accumulated, with in 617 the amount of payment made inclusive of interest paid. In 618 are inclusive the liabilities to pay, that are the residual amount to pay to the bank that including the residual payment, including the interest. In 619 a graph provide a visual percentage of the ownership of the quotas. In this case the creativity could create any type of graphical or animated visual effect showing the progressive in quota accumulation, and the remaining quota to acquire. It can stimulate to save and to meet the payment. In 620 is indicated clearly the interest rate that the customer is paying for the financing of the repurchase plan.

The system has effect if both parties, the customer and the bank or lenders, are agreed on this points, by signing a legal document:
the acquiring owner must pay an installment whose value is communicated, every month, by the bank if the interest is of the variable type, or according to the repurchase plan indicated above, if the interest is fixed.
Receiving, for each installment paid, a corresponding number of quotas or fractions calculated on the value of the capital part of the monthly installment of the amortization plan;
Being able to use the property following the payment of the monthly installment.
Customer can be able to effect additional payments for the acquisition of additional quotas, which will reduce the amount of quotas to be reacquired.
If the customer is not be able to pay the installments for the redemption, for a number of months, he/she will have to vacate the premises of the estate, and for each month of non-payment, the customer must return a quota or the relative fraction; the bank will ask to Clearing House subsystem (12) to transfer the quotas for the non-paid installments from the client's quota account to bank account, as described above and according to the procedure in FIG. 5

The customer will remain the owner of the quotas paid and will be able to sell or exchange these quotas, through a online Marketplace subsystem (14) operated by the bank or by an independent financial services company. For the whole duration of the contract, i.e. until the customer has reached full ownership of the property by acquiring all the quotas issued by the legal entity, the administration and control of the legal entity, and therefore the relative property, are effected by the bank or lender, derogating from contracts which regulate membership within companies such as LLCs, which can be the preferential form of legal entity of the legal entity. This measure is necessary for preventing the customer, once he has acquired the majority—i.e. 50%+1 of the legal entity quotas—from controlling the property, at will, as he/she is the owner of the majority of the legal entity quotas when structured in the form of an LLC, abusing the spirit of the acquisition method of the house according to the present invention.

The above system has various advantages: in short, it envisages a model of payment of monthly installments which can be comparable to a rent or mortgage installment, with the difference that whereas the monthly rent is lost, with this method, it is accumulated into ownership quotas of the estate, thus representing a form of saving and a capital accumulation represented by the estate. Compared to a traditional mortgage, the main advantage is to be able to use the property without requiring an actual loan from a bank to the customer of the estate and consequently without an actual debt towards the bank. In this way, people with a low credit rating or low income, or with a possible bankruptcy case in progress, can have the property at their disposal with the simple possibility of effecting monthly installments for the estate. At same time, the system is perfect for the acquisition of commercial real estate, where months after months they increase the equity value of quota, strengthen the balance sheet, better or a leasing agreement.

In addition, in the case of default of repayments continues for several months, the estate is not subject to the process of foreclosure and is therefore not put up for sale by the bank to recover the residual value of the debt, but simply transferred to a new customer who will start a new plan according to this system or will take over the existing one by acquiring the quotas owned by the old defaulted customer.

In doing this, it is possible to include in the system benefit or penalty in cases of devaluation or re-evaluation of the estate to be envisaged, where bank and owner can share or not risks and profits.

Another advantage of this system is the freedom of mobility that allows a subject to move freely to another city or area of the same city, as often happens in a highly “movable” society, characterized by frequent transfers such as the American society.

Thanks to the principle of the quotas owned, it is possible to establish an online Marketplace subsystem (15), so that if a customer who lives in New York and owns a number of quotas of his/her estate, needs to move to Los Angeles, he/she can sell his/her quotas of the New York property and, with the same money, can acquire a certain number of quotas of an estate in Los Angeles, more practically and rapidly with respect to a traditional mortgage.

Whereas in the case of an estate purchased by means of a traditional mortgage, the client should first sell the property in New York, through a real estate agent, pay the remaining debt to the bank and then, with the possible remaining capital, purchase an estate in Los Angeles, after searching for and signing a new contract for a mortgage with another lender. With this system, it is also possible to perform an exchange, but the two parties must have the intention of exchanging their respective properties. On the contrary, by using the system object of the present invention, thanks to the online Marketplace subsystem (15), described hereunder, it is possible to sell the ownership quotas of an estate in New York to another person in New York, and search for a house in Los Angeles a third person, using the accumulated quotas as down-payment to be paid for purchasing the new property in Los Angeles. This idea, in fact, allows a property to be “movable” thanks to the concept realized with the present invention, based on ownership quotas, as if they were company shares/securities. Consequently, the present invention allows “real estate” to become “movable property”.

For the functioning of this system, it is essential for the bank, in order to avoid excessive risks, to have a guarantee margin represented by the quotas owned by the customer and purchased at the beginning by a down payment. If the market price of the estate has decreased, the bank will use the quotas owned by the client in default to face said decrease in the price. Furthermore, the bank can automatically and dynamically establish a guarantee, updated each month, equal, i.e. to 20% or another percentage of the amount of the residual capital. Said residual capital, equal to the total residual quotas to be repurchased, changes every month, decreases when the installments are paid and increases when one or more installments are not paid. This further guarantee allows the bank a better management of the value of their property assets (owned by mean of legal entity) and avoids a financial crisis as the one of 2007-2008.

In addition, the method and system presented herein is characterized by low risks for the bank, as in the case of default, the hypothesis of foreclosure is avoided and the customer can negotiate an extension of the repurchase plan of the quotas. As can be seen, the quotas owned by the client can be used for immediately recovering the non-paid monthly installments and if these continue, evict the same and make it free the estate again, ready for a new subscriber; if the sales price of the estate to a new customer is lower than the initial one, the quotas accumulated by the client will be used, the bank will take possession of them on the basis of legal document agreed, in order to compensate the difference in price.

Table 5 summarizes the situation of the plan seen in table 1, after 5 years of regular installments. The quotas accumulated are 20.84 to which the initial quotas of the down payment must be added, making a total of 80.24 quotas.

TABLE 5

| Situation after 5 years | |
|---|---|
| Total payment | $107,880.00 |
| Principal paid | $20,836.00 |
| Interest paid | $87,082.00 |
| Quotas acquired | 20.84 |
| Total quota (initial + acquired) | 80.84 |
| Value of quota owned | $80,836.00 |
| Remaining quota value (to be | $279,154.00 |
| acquired) | |
| Remaining quota number | 279.16 |

Tables 6 and 7 hereunder show the cases of devaluation and re-evaluation of a property purchased by means of the present method and system.

If a property is to be purchased according to the present method and this has a market value higher than that paid for the initial acquisition, there is the situation shown in table 6. The estate in question which has a sales value of $400,000 determines an appreciation of the quotas of $8,921.78 for the quotas acquired by the owner, each of them having a value of $1,111.11 with respect to $1,000 of the original value. The remaining quotas, not yet acquired, generate an appreciation of $31,018.22.

The contract signed by the customer and the bank can establish a share of the profits in the case of appreciation, or the appreciation can be divided on the basis of the quotas actually owned.

TABLE 6

| Sales after 4 years - Increase in | |
|---|---|
| value | |
| Property value | $400,000.00 |
| Increase | $40,000.00 |
| Initial quota number | $60,000.00 |
| Capital acquired | $20,836.00 |
| Total quota number | 80.84 |
| Value quota owned | $80,836.00 |
| Initial quota value | $1,000.00 |
| Quota value with revaluation | $1,111.11 |
| Gain per quota | $111.11 |
| Quota residual number | 279.16 |
| Value increase in residual quota | $31,018.22 |
| Value quota owned | $89,817.78 |
| Gain for all owned quota | $8,981.78 |
| Gain for not owned quota | $31,018.22 |

Table 7 shows the case in which, in the case of the sale of the property, there has been a decrease in the value of the estate with respect to the initial price. The estate has a market value of $320,000 with respect to $360,000 paid before, generating an overall depreciation of $40,000. In this case, each of the 360 quotas has a value of $888.89 causing a depreciation of the quotas owned by the client equal to $8,981.79 and $31,018.22 for the quotas owned by the bank. In this case, on the basis of guarantee margin principle, the bank can recover the appreciation on the quotas owned by the client, or share the loss with the client, in accordance with the agreement signed about profit & loss of the property.

TABLE 7
Sales after 5 years - Decrease in value

| | |
|---|---|
| Property value | $320,000.00 |
| Decrease | −$40,000.00 |
| Initial quota number | $60,000.00 |
| Capital acquired | $20,836.00 |
| Total quota number | 80.84 |
| Value quota owned | $80,836.00 |
| Initial quota value | $1,000.00 |
| Quota value with devaluation | $888.89 |
| Devaluation per quota | −$111.11 |
| Quota residual number | 279.16 |
| Value increase in residual quota | −$31,018.22 |
| Value quota owned | $71,854.22 |
| Loss for all owned quota | −$8,981.78 |
| Loss for not owned quota | −$31,018.22 |

An expert in the field can easily see how it is possible, instead of having a system based on the reacquisition of legal entity quotas, by means of monthly payments including both capital and interests, as if it were an installment of a mortgage, it is possible to introduce a concept of a rent (equivalent to a quota or all the interest allowing the bank to have some cash-flow) without there being any transfer of quotas, as this procedure contemplates the payment of the interests only. In short, with this method, the client suspends the reacquisition of the quotas and has a lighter monthly installment. The reacquisition of the quotas can start subsequently, according to the availability of the client. This procedure can be used when the client has difficulty in paying the whole installment. It is also evident that the bank which owns property possessed by legal entities which does not have a client at that moment, can rent this property and have positive cash-flows thanks to the rental fees.

The alternative rental fee can be established on the basis of a fixed or variable interest rate equal to the remuneration of the residual value of the estate. The calculation basis would be the total of the values of the quotas owned by the bank when it has the option of using the rental fee instead of the installment. In this way, on one hand, the remuneration of the bank of the capital on the residual total capital is guaranteed, and on the other, the customer is offered the possibility of paying a lower monthly payment. If a customer does not even pay the rental fee, the latter will be subtracted from the amount of quotas accumulated by the client.

A second, simpler implementation of the invention is that in which the bank grants the client a real estate loan and, instead of receiving a mortgage as guarantee, the bank obtains the quotas of the relative legal entity as guarantee. Alternatively the bank purchases these quotas from the customer giving to him/her the loan to acquire the house. In this way, the loan is registered in the customer's name, who can therefore deduct the interests from his/her income tax declaration, like a traditional mortgage loan. The house however is in the name of a legal entity, as in the preferred implementation, with the same mechanism of reacquisition and transferring of quotas. In the same way in case of non payment, the bank will take quotas back as in the first implementation. This second implementation is like a buyback of quotas performed by the client in force of a repurchase plan. The quotas are calculated in the same way as the first implementation, In this case the loan is in the name of the customer, so that he/she can tax deduct the interest, whereas the loan of the bank (with the eventual down-payment of the client) is used for purchasing the estate and transferring its ownership to the legal entity used. Depending on the down-payment, which determines the number of quotas purchased immediately by the customer, each time a monthly payment is made, the bank “grants” a quota or fraction of a quota to the customer, who accumulates it in his/her own account.

If the customer does not pay the monthly installment, the sanction and penalty mechanisms contemplated in the preferential implementation intervene i.e. the transfer of the quota to the bank, which, in this case, would mean re-obtaining a quota or fraction of the quota or more, until eviction for excessive and repeated default and, finally, the return of the estate to the market. This quota is calculated on the interest part of each month installment unpaid. This implementation can be effected in the same way with the computerized software system. In this case the bank and customer will agree legally on this points.
the client accepts the financial obligation of a loan, which is transferred to the legal entity, in whose name the estate will be registered and the customer will receive quotas of said legal entity on the basis of the down-payment in effect; the bank will take the rest of quotas as guarantee against loan to the customer.
the customer undertakes to pay a monthly installment to the bank, calculated by the computer with an amortization plan;
the customer will receive a quota or fraction or more quotas of the legal entity in whose name the estate used by the client is registered, every time he succeeds in paying a monthly installment to the legal entity;
the customer accepts that, in the case of lack of payment of one or more installments, the bank will transfer one or more quotas or fractions of the legal entity as guarantee equal to the value of the interest portion of the monthly installments unpaid;
acceptance of the devaluation and re-evaluation mechanisms contemplated by the preferential implementation and negotiated between the bank and the client.

The use of this system is for the acquisition of a new house and can be suitable for the exchange and transfer system of quotas contemplated by the computerized Marketplace subsystem (15) as in the first implementation. Further considerations which could be made, will be omitted; an expert in the field will be able to easily implement this second implementation according to the objectives and effects of the first implementation, as in the flow diagrams and procedures seen for the first implementation.

A third implementation of the present invention is to use the present system for all current mortgage loans, in particularly in which there is insolvency on the part of the borrower and the risk of foreclosure, or need to renegotiate, by converting said loans into repurchase plans according to the present invention, thus avoiding foreclosure, allowing the balance of the banks to be readjusted, and a more affordable installment for the customer.

Therefore, if the owner who purchases a house according to this system is not able to pay the monthly installment, i.e. he/she is not able to reacquire the quotas in accordance with the established plan, the bank can effect several measures to protect its interests, as described above. When there are one or more unpaid installments, the bank will effect the transfer procedure of the quotas for each unpaid monthly installment. Should the default continues, the bank can simply evict the customer—on the basis of the contractual agreements—and find a new owner to replace the previous one, i.e. he will continue the acquisition plan of the house according to the present method. The risk for the bank is limited with respect to traditional mortgages, as the bank, by legal contract, will always be the owner of the legal entity that owns the house until all the quotas are totally reacquired. The greatest burden for the bank is to find a new owner or person to take over the plan, through the marketplace and thanks to the particular characteristic of this system, however, it will be easy to find people who need a house and want to use this system instead of purchasing it through a traditional mortgage based on a loan or instead of being simple tenants, as this system is more accessible with respect to acquisition through a loan mortgage.

Furthermore, in the case of a traditional mortgage, a low credit rating of the borrower implies a higher interest rate, whereas, using the present method, there is no financial risk for the homeowner as there is no loan towards the latter (except for the second implementation where the loan is backed by a legal entity's quotas), but only the capacity of reacquiring the quotas. The interest rate will therefore normally be lower also for people with a low credit scoring.

The conversion of a loan into a repurchase plan according to the present invention has benefits for the bank. A mortgage loan of $100,000 is registered by the bank as a credit with respect to the client and is therefore subject to the risk of insolvency of the client. This credit is registered in the assets of bank accounts, under the item credits towards clients, as per table 2.

With this system, on the contrary, at the beginning of the plan, a house with a value of $120,000 is considered an asset owned by the bank through the legal entity in whose name the property is registered, and is therefore situated among the assets, but as “financial securities” or “financial instruments” and as the customer gradually buys his/her quotas, the value of this asset diminishes—as the legal entity quotas, owned by the bank decrease—until total reacquisition on the part of the customer.

This third implementation is effected by the same computerized software system of the first and second embodiment.

In this case, the property is transferred from the owner of the house (or the borrower of the original loan) to the legal entity indicated by the bank. On the basis of the value of the loan and its duration, the legal entity will be subdivided into a certain number of quotas. The former borrower will receive a congruous number of quotas, equal to the value of the down-payment and of the capital which has matured up to the moment of conversion. The remaining legal entity quotas will be owned by the bank.

In order to establish the price at which the conversion will take place, one of the following options can be considered, according to the convenience and the conditions of the property market:

a) the original price of the loan
b) the present market price of the estate
c) an arbitrary price between the original price of the loan and the present market price.

Once is agreed on the price to which make the conversion into a repurchase plan, the whole amount established is subdivided into certain quotas. 360 quotas are assumed for a property whose accepted value for the transaction is $300,000, so that each quota has a value of $833.33. The initial down-payment and the paid installments of the original loan, form a capital of 100,000 $ which grants the right to receive 120 quotas of the legal entity owner of the property. The financing of the remaining quotas to be purchased is implemented by the bank on the remaining part ($200,000), which converts the residual capital of the loan into relative legal entity quotas. At the moment of the conversion, it will be possible to extend the reacquisition period or change the interest rates or introduce other conditions agreed on between the parties.

Once the agreement has been signed, the loan ceases to exist as a result of this agreement and the customer's engagements are those contemplated by the repurchase plan mentioned above. The bank can therefore cancel the credit from the client and can register in the assets “financial instruments” or “marketable securities”, the value of the legal entity quotas in his possession.

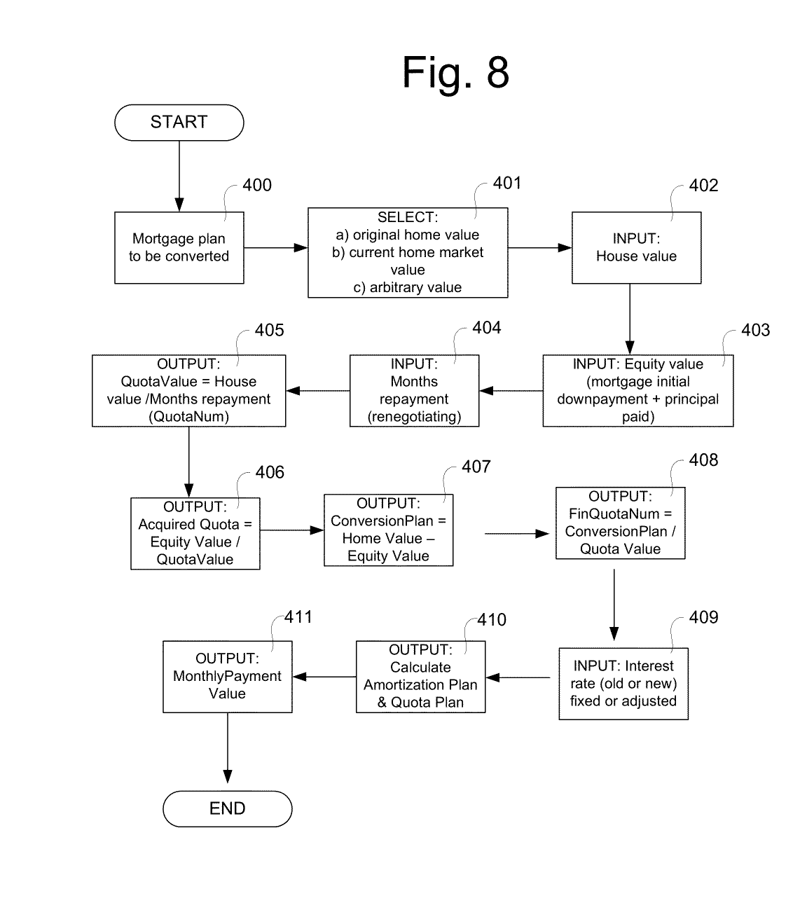

FIG. 8 represents a block scheme for the conversion of a loan into a reacquisition plan according to the present invention. The loan to be converted (400) can be in default or requires a reconversion, the price of the estate to be considered is selected (401), and this can be the original value (a), the current market price (b) or an arbitrary value (c) agreed upon by the parties. The selected value (House value) to be used is inserted (402), the Equity value of the house is calculated (403), i.e. adding what has been paid so far as capital during the initial mortgage loan repayment, and the value of the initial down payment at the time of the loan. The re-payment months (404) of the conversion plan are subsequently inserted, following renegotiation of the terms of the loan to be reconverted, for convenience, the months of re-payment determine the number of quotas into which the legal entity must be divided. In (405) the value of each quota (QuotaValue) is calculated, dividing the selected value of the house (House Value) by the number of months or the number of quotas (QuotaNum) which has been established. The computerized system returns the quantity of the Acquired Quotas (406) dividing the Equity value by the value of each quota (QuotaValue), whereas the amount for financing (ConversionPlan) the acquisition (407) of quotas is obtained by subtracting the Equity value from the established value of the house (Home Value). The financing amount is converted into quotas (408) (FinQuotaNum), dividing the financing amount (ConversionPlan) by the unitary value of the quota (QuotaValue). The insertion of the interest rate (409) subsequently allows the amortization plan and quota reacquisition plan to be calculated and obtained (410), as shown in table 4. The amount of the monthly installment of the reacquisition plan, according to the present invention, is then established (441), following conversion of a traditional mortgage.

By using this system, it is not even necessary to implement complex securitization and similar instruments such an ABS (Asset Based Securities), CDO (Collaterized Debt Obligation) as it is not necessary to transform the mortgages into “securities” as the reacquisition plans are already Securities, i.e. the legal entity quotas are Securities and can be exchanged by the banks carrying with them the repurchase obligations on the part of the house owner/renter. Should synthetic instruments which include these Securities be created, the same can be produced by creating financial instruments “which contain” homogeneous repurchase plans or which have a diversified or homogeneous risk profile and geography.

In this way, banks can sell their repurchase plans to third investors, receiving liquidity to implement new repurchase plans. Contrary to the ABS, CDO, which, de facto, were obligations, structured on a set of loans, which could have a high interest in relation to the risk of the subordinate but high-risk loans, as has been seen, in the case of securities based of repurchase plans based on the present system, the rates would be lower but, at the same time, they would have a lower risk, due to both the direct guarantee represented by the legal entity quotas and also because the interest rates applied for financing the reacquisition of quotas would, in turn, be lower. In this sense, this invention helps to stabilize the interest rates of real estate operations, reducing the risks for the entire system and for all the participants, specifically thanks to the fact that there is a direct and ready to marketable collateral, represented by the legal entity quotas which remain the property of the bank or financer, until they are gradually redeemed by monthly repayments.

This method, no matter how it is implemented, either for the acquisition of a property or for the conversion of a mortgage, also contemplates and handles cases in which restructuring and improvement works are necessary or are implemented on the estate If these works are required initially, when the estate is purchased according to this system, the same can be financed by the bank and will involve an increase in the monthly rate and the unitary value of the quotas. If, on the contrary, they are implemented after the purchase and are financed by the client, the bank, in order to include these positive variations which increase the value of the estate and consequently the legal entity, will increase the number of quotas equal to the amount of the restructuring expenses and will transfer them to the client.

When the restructuring is completed after the purchase and requires a financing from the bank, this financing will be added to that already underway, increasing the value of the monthly installment and increasing the value of the residual quotas or increasing the number of quotas, so that the amount of the installment remains the same, or the plan is extended. If a contrary case occurs, due to negligence, damage not covered by the insurance or other negative events which cause a loss in the value of the property, the bank will implement a transfer of the quotas owned by the client until the damage or the devaluation has been compensated. The client will then reacquire said quotas and will accept an extension of the repurchase plan or an increase in the monthly installments.

A fourth implementation of this method may not only be used for acquiring a house, but using the securitization of house in an legal entity with quotas, under this system, it is possible to use the quotas as guarantee or collateral in a large number of loans: business loan, student loan, car loan, and for all financial need where a collateral is required. Once the house is owned by a legal entity, part of the quotas of this legal entity may be used as collateral for loans. The guarantee quotas are transferred from the borrower account to the bank account once the loan will be obtained. The borrower will buy back the quotas using the repurchase plan system presented above. For the sake of simplicity the entire process of this fourth implementation will not show, but is quite similar to the process of the first implementation. A person skilled in the art may easy understand how to perform this implementation by adapting the original system.

The legal entity can be registered as an LLC, a Limited Liability Company or it can be an LLC Series, or a particular form of LLC contemplated in the State of Delaware and other states ((Illinois, Iowa, Nevada, Oklahoma, Tennessee, Texas, Utah and Wisconsin) which allows a main unit and a whole series of subordinate units (Series) in whose name the single properties are registered, so that the management costs for the bank can be reduced with respect to the costs for separate LLCs. According to the law of Delaware, in fact, each Series is legally considered independent of the other Series, with the possibility of having different members (the owners) for each Series and different assets, and, from a patrimonial point of view, each Series is considered independent of the others. In this way, it is possible to issue an arbitrary number of quotas on the basis of the values of the single properties and reacquisition plans suitable for each client, so that each quota corresponds to a membership unit of a LLC or a Series of LLCs. Alternatively, a further form for implementing the plan is to use a special purpose vehicle company as legal entity, a specific company for this, assisted by a bank or financial institution which acts as legal entity, under this system—in whose name various estates belonging to different clients are registered, using the following plan. In this case, the quotas are not representative of the capital of the HPV but are fictitious and purely accounts units or quotas. In this case, the ownership of the estate will be transferred by the bank to the customer once the latter has completed the reacquisition of all the quotas. Once this system is in wide use, it will also be possible for certain states and jurisdictions to create specific special legal entities according to the spirit of the present invention, so as to allow the division of the quotas into a variable number and be specific for managing estates not only for residential but also for commercial or industrial purposes, to which the present system can be applied.

A single legal entity can also be used for a number of properties, using the principle of joint-stock companies or entities whose property is represented by shares, so as to reduce the administration and management costs deriving from the use of various legal entities, such as LLCs or LLC Series.

In this case, the legal entity is a joint-stock company or with a variable capital or a real estate fund, in whose name the properties purchased are registered, when new estate acquisition plans are signed by new purchasers.

In the hypothesis of a single legal entity, with the capital represented by shares, divided into different classes or series, so that each class of stock represents the capital of a single property, and act as a “legal entity” definition under this system. For indicating one series with respect to another, a progressive numbering or the letters of the alphabet or a mixture of both can be used for univocally indicating the class of shares, so as to associate the corresponding estate for each repurchase plan. The quotas for each legal entity will be transferred each month, as same way described above. The use of different classes avoids having to make calculations for adapting the value of the shares already issued, in the case of the issuing of shares for a new property which is added to the fund, when a single class of shares is used. This legal entity would specifically act as an estate investment trust, but the use of different classes allows a better separation of the single estate assets and at the same time avoids calculations for adapting the price of each share each time a new estate is added in the hypothesis of a single class/series of shares for all the properties. It is evident that, by issuing a new series or class of shares for each estate, the problem does not arise, as the estate will refer to that class/series and to the capital of that class and consequently the relative shares will represent the value of the estate. Substantially, there is property segregation as in the case of a LLC Series, with the advantage of assigning the equity of each class of shares to a specific estate. This equity is composed of the quota paid by the bank and the down-payment of the customer.

At the end of the payment/reacquisition of all the shares, the estate is transferred from the legal entity to the customer or this latter .can decide to maintain the property be mean of legal entity, instead having the property directly owned by himself/herself.

One of the advantages in dividing the value of a property into various quotas is that the quotas can be exchanged between different subjects. Each owner of a house according to the present system, who wishes to change house or move to another town, can exchange his quotas or sell them on an online marketplace (15), i.e. an internet website which collects and shows the estates for sales, whose quotas and the uncompleted repurchase plan are put on the market by the current owners.

This online Marketplace subsystem (15) is implemented through a suitable software application and hosted on a server of the internet network or another computerized network, contains the following sections:
user area: which indicates the data of the customer
estate area: which shows the data for identifying the estate, the floor plan, photos, cadastral surveys, a link with a geo-localization and visualization system of the estate on maps
repayment plan area: which shows the historical cost of the estate, the number of quotas into which the estate is divided, the number of quotas owned, their value and the remaining value of the quotas to be acquired to end the plan, indicating the net cost without interest, and total cost including interest
the current value of the estate, calculated by means of an evaluation by an expert or automatically calculated using a price index of the properties, according to the type of property and residential area and other useful characteristics which determine the value of an estate, or by means of other arbitrary criteria for determining the price.
a search engine which allows the estates present on the marketplace to be sought by type, city, value and other parameters essential for the search for properties on sites containing estates for sale.

This data can be acquired directly from the data of the bank which has financed the repurchase plan according to the present method, by means of an exchange of data between the Marketplace subsystem (15) and the Information System of the bank (18), with or without using of the Interface subsystem (17) once the owner has communicated to the bank—also through his own online account—his intention of selling or exchanging his quotas by putting them on the market. With the sale, the customer sells his/her own plan, i.e. his/her house, with the benefit of possible increases in value or facing a possible loss in value, like traditional methods for the purchasing of an estate (loan, leasing, cash payment), by liquidating the quotas in his possession.

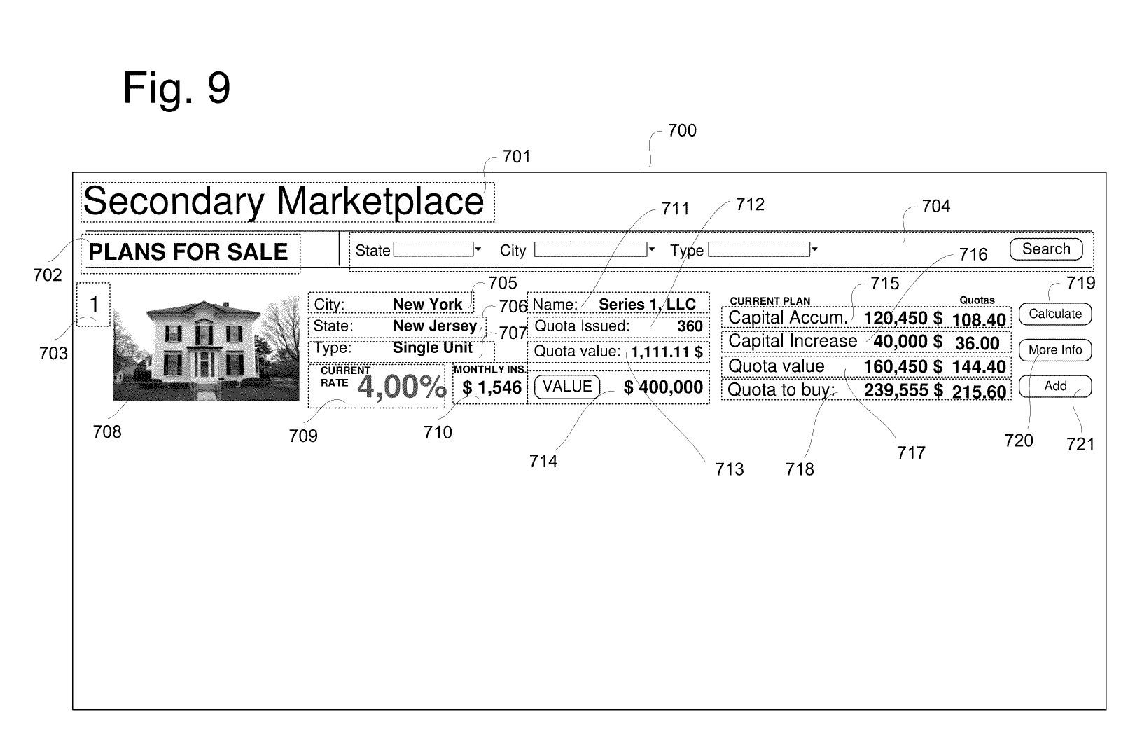

In FIG. 9 is showed an example of user interface (700) that the Marketplace subsystem (15) could have, as viewed in a browser for a desktop pc. At same way, and changing the interface is possible to obtain a compatible version for smartphones or tablet as an “app”. In this case is showed an example with arbitrary value, different from the value used in the tables above. In this case a plan with accumulated quota is put on sale, to a new buyer that will take up the accumulated quota and continue to repurchase the remaining quotas.

The website has a title (701), and a section where it is showed the title of the section (702). The section 703 is a simple search engine where is possible to make a search of plan for sale based on state, city, type of properties. The result of this search is the example listing showed below. With a 703 is the progressive number of the listing, as resulting of the search engine (703) result. A photo (708) of the property for sale, Then it is showed the city (705), state (706), type of property (707). The section 709 show the interest rate of the repurchase plan set on sale and with 710 the monthly installment. With 711 is showed the name of legal entity, the number of quota issued (712), the value of each quota (713), and the value of the legal entity (and than of the property) on sale. In section 715 is showed the accumulated capital or the value of the quota accumulated by the seller of the plan and the corresponding number of quota. In 716 is showed (optionally) the capital value increase (that could be included and added in section 715, while in 716 is showed the total quota value and number for sale by the seller, as sum of 715 and 716, and in section 718 is showed the residual number of quotas to acquire and their value. By clicking button 719 is possible to calculate a new repurchase plan, or by clicking on 720 ask more information about listing or with 721 add the listing to the preferred list for a later consultation.

The user interface (700) is only an example of data and information that is possible put in a typical listing of a marketplace (15) for the sale of plan under this system.

It is evident that the Marketplace subsystem (15) will act as a property search site, like an analogous real estate website and, as a further benefit, will also offer a saving thanks to the reduction in brokerage costs of real estate agents or other intermediaries, also computerized, thanks to the price information, sale or exchange of quotas, thus reducing transaction costs: at the same time, it is not even necessary to pay the registration or property transfer taxes as there is no transfer of estate—which remains in the name of the legal entity—but of the owners of the quotas of the relative legal entity, which can be easily effected by means of a simple transfer agreement of the legal entity quotas.

1. A software system for implementing a reacquisition plan of securities of a legal entity that holds a real estate property; said software system is implementing an incremental reacquisition plan of a real estate property, without using a monetary debt balance; said real estate property is initially registered in a legal entity's name whose capital is represented in quotas, wherein said quotas represent an entire monetary value of said real estate property; said quotas being transferred by a bank institution, which is the initial owner of the legal entity and consequently is the initial owner of the real estate property, to a purchaser according to an incremental repurchase plan; said software system provides the steps of an incremental purchase of the quotas, upon payment of monthly installments, each installment comprising a principal amount and an interest amount until the purchaser reaches a full possession of an entire number of quotas of the legal entity owner of the estate; said part of principal corresponds to the value of the quotas transferred by said bank institution to the purchaser; and wherein quotas, already owned by the purchaser, can be transferred, sold and applied to purchase a different real estate property in a different location using an online marketplace system.

2. The software system according to claim 1, wherein said system comprises a Main System software application comprising the following subsystems, each accessing its relative databases and data storage facilities:
a. a software secure interface subsystem to allow access to the Main System, said access is reserved to third party banks, lenders, financial company systems, to allow an exchange of financial data between the Main System and the third parties;
b. a Plan Origination subsystem where third parties can create, modify and delete a repurchase plan;
c. a Plan subsystem where a repurchase plan is stored, with data associated to a legal entity used, related real estate property and financial data of the repurchase plan, and a transaction history and quotas balance;
d. a Legal entity subsystem capable to have a registry of the legal entity, and capable to be electronically linked to a government company information system to create a new legal entity or delete or modify an existing one; further comprising software capable of providing administration and accounting services for the legal entity;
e. a Real estate subsystem acting as a registry for the real estate that is linked to a title company system to maintain updated the title owner of a real estate;
f. a Shares subsystem capable to operate as a shares registry for every legal entity, where the quotas owned by a purchaser and quotas owned by a bank or financial institution are recorded and updated based on transactions made by the parties, according to a repurchase plan;
g. a Clearing house subsystem capable to act as a clearing house, using instructions received by a bank or financial institutions to achieve settlement and clearing of quotas and updating a shares registry;
h. a Securitization Engine subsystem capable to create asset-backed securities based on the quotas of a repurchase plan; said quotas are selected according to a plan based on geographic criteria, type of properties, duration, and credit score, and other secondary criteria, wherein the output generated is a set of quotas meeting the above criteria, said quotas will be part, together with a calculated interest rate, to create structured securities that include a different quotas from different repurchase plans.

3. The software system according to claim 1, wherein said purchaser can make an initial down payment and obtain, a corresponding number of quotas of the legal entity owner of the estate, that will be credited on a purchaser's account; said account is accessible electronically via a smartphone software and by online software applications.

4. The software system according to claim 1, wherein said quotas are gradually transferred from an electronic account of the bank to the purchaser's account, and wherein the value of the quota or quota fraction transferred is preferably equal to a principal portion of a monthly installment calculated by means of an amortization system by using a method of constant or variable installment amortization which stores an initial capital allocated by the bank to finance the real estate purchase.

5. The software system according to claim 1, wherein said software system calculates all financial amounts of the gradual repurchase plan, the number and value of the quotas into which a legal entity capital is subdivided into; said software system executes the following steps:
a. entering into the software system an estate property value;
b. entering in the software system a number of capital quotas of the legal entity, which can be preferably equal to the number of months during which the total number of quotas are to be repurchased or the total number of quotas set to other arbitrary value;
c. the software system calculating a single quota value by dividing the real estate value by the number of quotas;
d. entering in the software system a down payment amount;
e. the software system assigning a number of quotas to the purchaser by dividing the down payment by the quota value;
f. the software system calculating a number of quotas which will be financed and owned by the bank by subtracting the quotas owned by the purchaser from the total number of quotas;
g. the software system calculating a current value of the purchase plan by multiplying the number of financed quotas by their unit value;
h. entering in the software system a fixed or variable interest rate to be applied;
i. the software system calculating an amortization plan, preferably using a French model, to compute the value of the purchase plan financed by the bank, printed or displayed on a computer monitor, said purchase plan comprises, for each month, the value of the quota or quota fraction corresponding to the principal portion of each monthly installment.

6. The software system according to claim 1, wherein, in case of non-payment of at least one installment, the software system will transfer, one or fractions or more quotas of the legal entity that owns the property from the purchaser electronic account to the bank's account; said transferred quotas being calculated, so that they are equivalent to the interest part of each non-paid monthly installment.

7. The software system according to claim 1, wherein, in case of sale of an estate purchased according to the present system, whenever its sale price is lower than the initial sale price, thus resulting in a capital loss and a depreciation of the value of the quotas, the bank takes all, or part, of the accumulated quotas of the purchaser to compensate the loss of value relative to the quotas owned or the bank uses other means of loss sharing.

8. The software system according to claim 1, wherein in case of sale of an estate purchased according to the present system even if the corresponding repurchase plan is non-completed, whenever the sale price is greater than the initial price paid for the real estate property, a corresponding capital gain and increase of value of the quotas is subdivided proportionally to the quotas owned by the bank and the quotas owned by the purchaser.

9. The software system according to claim 1, wherein said software system uses a software application interfacing with an on-line system of a government company register, to create a new legal entity for each real estate property acquired using this plan; wherein said new legal entity is a company selected from the group consisting of LLC, LLC series, joint stock company or other form of a legal entity.

10. The software system according to claim 8, wherein said software application has created a new legal entity in the form of a joint stock company, and wherein for each real estate property, a specific class of stocks, with segregated assets and quotas, is used.

11. The software system according to the claim 1, wherein said quotas, reduced by the number of quotas of the down payment, are owned by the bank, which purchases a number of quotas for financing the ownership of the real estate property.

12. The software system according to claim 1, wherein said monthly installment paid by the purchaser can be increased by an annual real estate expenses, distributed in monthly amounts, these expenses are:
state taxes on the real estate property
insurance premiums
management and administration costs of the legal entity
any other administrative and instrumental costs.

13. The software system according to claim 1, wherein said software system further performs a transformation of a mortgage loan into a gradual repurchase plan having a same reversing mechanism as the one used in case of one or more installments are not paid, and wherein the software system is comprising the following functions:
a. determining a conversion value by selecting among: the original value of the real estate at the time of the loan; or the current market value; or an arbitrary and negotiated value which is entered into the software system;
b. calculating an equity value corresponding to the quotas to be assigned to the purchaser; said quotas are calculated on the basis of an initial down payment and of the accumulated principal of the paid installments of the original mortgage loan;
c. entering into the software system a number of months of the repurchase plan duration and determining the number of quotas in which the estate is subdivided;
d. calculating the value of each quota, by dividing the agreed real estate value by the number of months of a repayment plan, thus obtaining the number of quotas into which the legal entity capital is divided;
e. calculating the number of quotas acquired by the purchaser by dividing the equity value of the real estate property by the unit value of each quota;
f. calculating the value of the conversion plan which will be financed by a bank by subtracting the entity value accumulated by the purchaser from the used estate value;
g. calculating the number of quotas financed by the bank by subdividing the value of the conversion plan by the unit value of each quota;
h. entering in the software system a fixed or variable interest rate;
i. calculating a new amortization plan, the amount of the monthly installments and the value of each quota or fraction thereof for each monthly installment of the plan, said new amortization plan is displayed on a computer monitor and stored on a database.

14. The software system according to claim 1, wherein said purchaser receives a loan from the bank to acquire the real estate property by using a legal entity, and said purchaser having the ownership of the quotas, will give them to the bank as guarantee and wherein the bank will remove said guarantee by transferring for each paid installment the relative number of quota or quota fraction gradually transferred from the bank's quotas account to the purchaser's account or, in case of non-payment by the purchaser, the bank will obtain, purchaser's quota transferred from the purchaser's account to the bank's account.

15. The software system according to claim 1, wherein said software system is applied to obtain loan and credit financing from a bank using an estate property, wherein said estate property is registered in a legal entity's name and whose quotas can be used as a guarantee or transferred directly to a bank, which will give a loan to the purchaser now acting as a borrower, by paying back the loan in monthly installments to receive back from the bank quotas or fraction of a quota, said quotas are transferred from the bank's account to the borrower's account.

16. The software system according to claim 1 further comprising the step of allowing to exchange, via an online system, quotas accumulated by a purchaser of a legal entity owner of an estate, with those of another purchaser who has a repurchase plan relative to another estate by using an online marketplace system or other computerized system, by compensating using cash the difference between the two real estate values.

17. The software system according to claim 1, realized by means of a computer-based system, is operating as a server on the Internet, to support the implementation of a marketplace system of repurchase plans, which allows to exchange said plans between different buyers or to allow to sell the quotas and the associated repurchase plan to another purchaser.

18. The software system according to claim 17, wherein said marketplace system comprises software executed by a computer, connected to the Internet, apt to display on a monitor a web page containing the following information:
a. user area: which indicates the data of the owner;
b. estate area: which shows the data for identifying the estate property, the estate's floor plan, photos, cadastral surveys, a link with a geo-localization and visualization system of the estate on maps;
c. repayment plan area which shows the historical cost of the estate, the number of quotas into which the estate is subdivided, the number of quotas owned, their value and the remaining value of the quotas to be acquired to end the plan, indicating the net cost without interest, and total cost including interest;
d. the current value of the estate property, calculated by means of an evaluation by an appraiser or automatically calculated using a price index of the properties, according to the type of property, residential area and other useful features which determine the value of an estate, or by means of other arbitrary criteria for determining the price, further comprising a computerized search engine which allows the estates currently on the marketplace to be sought by type, city, value and other parameters essential for the search for properties on sites containing estates for sale.

19. The software system according to claim 1, wherein said incremental purchase plan of the quotas by payment of monthly installments, is suspended in case of an hardship situation of the purchaser, allowing the purchaser, by accessing its account, to pay to the bank only the interest based on the quotas still owned by the bank, to emulate a rental fee.

20. The software system according to claim 1, wherein said quotas, are increased in number or their unit value is increased to meet the additional financing requirement in case of improvements or restructuring of the property by the purchaser; and wherein additional financing of the improvements by the purchaser is not required, such in case the purchaser is personally financing the improvements, the number of quotas of the legal entity is increased and additional quotas are transferred to the purchaser to compensate for the value of the improvements; and wherein the value of the property purchased is decreased because of damage or negligence not covered by insurance, the bank will transfer quotas from purchaser's account to its account, until the loss of value is compensated or the purchaser will acquire these quotas via an extension of the repurchase plan or by an increase of the monthly payments.
